(19) United States
(12) Patent Application Publication
(10) Pub. No.: US 2019/0055470 A1
(43) Pub. Date: Feb. 21, 2019

(54) HYDROPHOBIC-HYDROPHILIC SWITCHABLE POLYMERS FOR USE IN AGRICULTURE

(71) Applicant: COMMONWEALTH SCIENTIFIC AND INDUSTRIAL RESEARCH ORGANISATION, Australian Capital Territory (AU)

(72) Inventors: Priscilla JOHNSTON, Elsternwick, Victoria (AU); Raju ADHIKARI, Glen Waverley, Victoria (AU); Keith L. BRISTOW, Townsville, Queensland (AU)

(73) Assignee: COMMONWEALTH SCIENTIFIC AND INDUSTRIAL RESEARCH ORGANISATION, Australian Capital Territory (AU)

(21) Appl. No.: 16/078,758

(22) PCT Filed: Mar. 21, 2017
(86) PCT No.: PCT/AU2017/050255

§ 371 Date: Aug. 22, 2018

(30) Foreign Application Priority Data
Mar. 21, 2016 (AU) 2016901048

(51) Int. Cl. C09K 17/30; C09K 17/52

(52) U.S. Cl. CPC C09K 17/30; C08G 18/348; C09K 17/52

(57) ABSTRACT

A process for regulating the water retention of soil materials used in agriculture involving providing a composition comprising a polymer selected from the group consisting of a urethane, a urethaneurea, a thiocarbamate and mixtures thereof, said polymer comprising hydrophobic and hydrophilic segments; and applying the composition onto soil materials used in agriculture to form a polymer film thereon, wherein the hydrophobic and hydrophilic segments together provide reversible hydrophobic-hydrophilic switching in response to water, such that the film surface switches from a relatively hydrophobic state in dry conditions to a relatively hydrophilic state in response to the presence of water in contact with the film surface.

### TECHNICAL FIELD

The invention relates to hydrophobic-hydrophilic switchable polymers for use in agriculture. The invention further relates to a process for regulating the water retention of soil materials used in agriculture using such hydrophobic-hydrophilic switchable polymers.

### BACKGROUND OF INVENTION

The following discussion of the background to the invention is intended to facilitate an understanding of the invention. However, it should be appreciated that the discussion is not an acknowledgement or admission that any of the material referred to was published, known or part of the common general knowledge in Australia or any other country as at the priority date of any one of the claims of this specification.

A significant issue in the agricultural industry is the management of soil moisture. A lack of water in the soil can result in low crop production and crop failure. Soils may lack sufficient moisture due to infrequent rainfall, loss of moisture through drainage and also through evaporation. One option for managing soil moisture is to increase the amount of water stored in the soil. By improving the soil's ability to hold and retain moisture, crop yields can be improved and the risk of yield losses due to drought reduced.

One approach for increasing the amount of water stored in the soil is to use a physical barrier to prevent evaporation. A common example is a plastic mulch, which is typically a thin sheet of plastic with openings through which the crops grow.

The plastic which is most widely used in plastic mulches is a preformed continuous non-biodegradable polyolefin film which is spread over the soil using specialist application equipment to shape and apply the plastic to prepared soil. Crops are planted through cuts or holes produced in the plastic. The plastic film must be deployed before use and removed after each growing season (or series of seasons) which contributes to a significant increase in cost through material and transport, additional associated labour, specialist equipment and end of life waste disposal. The plastic is frequently unable to be recycled due to factors such as contamination of the plastic and the transportation distance required to access a recycling facility Complete recovery of the waste plastic can also be problematic as a portion of the plastic may be buried, may become torn and partly degraded and thus difficult to recover. Consequently, plastic that is not recovered presents not only a significant environmental problem, but can complicate the preparation and deployment of new plastic in successive growing seasons.

Furthermore, while plastic mulches can act as a barrier to reduce evaporation of water from the soil, this barrier can also prevent overhead crop irrigation or rainfall from entering the soil and thus reduce the amount of water available to the soil. Drip irrigation is frequently used as a water source for crops grown in plastic mulches.

The present invention seeks to provide a process for managing the moisture of soil materials used in agriculture, which will overcome or substantially ameliorate at least some of the deficiencies of the prior art, or to at least provide an alternative.

### SUMMARY OF INVENTION

According to a first aspect of the present invention, there is provided a process for regulating the water retention of soil materials used in agriculture comprising

(a) providing a composition comprising a polymer selected from the group consisting of a urethane, urethaneurea, a thiocarbamate and mixtures thereof, with said polymer comprising hydrophobic and hydrophilic segments; and

(b) applying the composition onto soil materials used in agriculture to form a polymer film thereon, wherein the hydrophobic and hydrophilic segments together provide reversible hydrophobic-hydrophilic switching in response to water, such that the film surface switches from a relatively hydrophobic state in dry conditions to a relatively hydrophilic state in response to the presence of water in contact with the film surface.

In one embodiment, the film surface undergoes a reversible change in water contact angle of at least 10°, preferably at least 20°, more preferably at least 25°, when switching from a relatively hydrophobic state to a relatively hydrophilic state. Preferably the film surface has a water contact angle of >90° in a relatively hydrophobic state.

In one embodiment, the polymer is derived from the reaction product of a linker selected from diisocyanate, ester, carbonate, and amide; a hydrophobic macromonomer having at least two active hydrogen groups selected from hydroxyl, thiol and amine; and a hydrophilic macromonomer having at least two active hydrogen groups selected from hydroxyl, thiol and amine, wherein the hydrophobic macromonomer provides said hydrophobic segment and the hydrophilic macromonomer provides said hydrophilic segment.

The polymer comprises segments of hydrophobic macromonomer and hydrophilic macromonomer joined by linkages independently selected from the group consisting of urethane, urethaneurea and thiocarbamate linkages.

The hydrophobic and hydrophilic segments are provided by macromonomers which are generally polymeric macromonomers. In one embodiment, the hydrophobic macromonomer is selected from the group consisting of poly(siloxanes), fluoropolymers, poly(butadiene)/isoprene, poly(caprolactone), poly(lactic acid), poly(3-hydroxyalkanoates), polymers derived from fatty acids, polymers derived from lignin and mixtures thereof. Preferably the hydrophobic macromonomer is selected from the group consisting of poly(siloxanes), poly(caprolactone), poly(lactic acid), poly(3-hydroxyalkanoates), polymers derived from fatty acids, and mixtures thereof.

The hydrophobic macromonomers have a molecular weight of 500-5000 g·mol⁻¹. In one embodiment, the hydrophobic macromonomer has a molecular weight selected from the group consisting of at least at least 750, at least 1000, at least 2000, at least 3000 and at least 4000. Accordingly the corresponding hydrophilic polymeric segments will generally have a molecular weights in this range.

In one embodiment, the hydrophilic macromonomer is selected from the group consisting of poly(ethylene glycol), poly(saccharides), poly(vinyl alcohol), poly(glycolic acid), poly(peptides) and mixtures thereof.

The hydrophilic macromonomers have a molecular weight of 500-5000 g·mol⁻¹. In one embodiment, the hydrophilic macromonomer has a molecular weight selected from the group consisting of at least 750, at least 1000, at least 2000, at least 3000 and at least 4000. Accordingly the corresponding hydrophobic polymeric segments will generally have molecular weights in this range.

In a preferred set of embodiments the polymer backbone will comprise both hydrophilic segments and hydrophobic segments. Additional segments of hydrophilic or hydrophobic nature may be present in side chains of the monomer units if desired. For example side chains may provide sites for cross-linking of the polymer.

In one embodiment, the molar ratio of the hydrophobic macromonomer to the hydrophilic macromonomer is between about 0.05:0.95 and 0.95:0.05.

In one embodiment, the hydrophobic macromonomer is poly(dimethylsiloxane).

In one embodiment, the hydrophilic macromonomer is poly(ethylene glycol).

In one embodiment, the polymer is derived from a reaction product that comprises no more than 5 wt % of a non-ionic chain extender.

In one embodiment, the polymer is derived from a reaction product that further comprises up to 15 wt % of an ionic species. Preferably, the ionic species is selected from the group consisting of

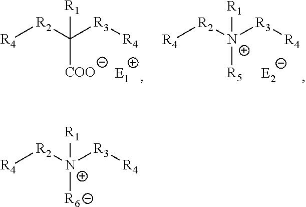

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic.

Examples of diisocyanates which may be used in preparation of the polymer include those selected from the group consisting of hexamethylene 1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, alkyl-lysine diisocyanate, dicyclohexylmethane diisocyanate, isophorone diisocyanate, 1,4-cyclohexane diisocyanate, 1,4-cyclohexane bis(methylene isocyanate), 1,3-bis(isocyanatomethyl) cyclohexane, and mixtures thereof.

In one embodiment, the polymer has a number average molecular weight of 30 000-200 000, preferably 50 000-120 000.

In one embodiment, the composition further comprises one or more additives selected from the group consisting of, fillers, thickeners, agrochemicals and surfactants.

In one embodiment, the composition comprises hydrophobic fillers selected from the group consisting of charcoal, graphene, talc, hydrophobic clays, organo-substituted silicas, organo-substituted cellulose and mixtures thereof.

In one embodiment, the composition comprises hydrophilic fillers selected from the group consisting of silicates, humates, phosphates, starch, micro/nano-crystalline cellulose, acid-functionalised micro/nano-crystalline cellulose, hydrophilic clays and mixtures thereof.

In one embodiment, the composition is provided as an aqueous dispersion. Preferably, the polymer is present in an amount of from 1 wt % to 60 wt % of the aqueous dispersion.

In one embodiment, the composition is applied onto the soil materials by spray application.

In one embodiment, the composition is provided as a pre-cured film.

In one embodiment, the polymer comprises a copolymer segment of Formula 1

A¹-Y¹-L-Y²-A² Formula 1

wherein

A¹ and A² which are the same or different, represent the remainder of the polymer backbone or terminal functional groups of the polymer;

Y¹ is the hydrophobic segment;

Y² is the hydrophilic segment; and

L is a divalent linking group selected from diisocyanate, ester, carbonate and amide residues which form independently selected urethane, urethaneurea or thiocarbamate linkages with each of Y¹ and Y². Preferably L is a divalent linking diisocyanate residue which forms independently selected urethane, urethaneurea or thiocarbamate linkages.

In one embodiment, the polymer comprises a copolymer segment of Formula 1a

A¹[-X¹-L¹]ₘ-Y¹[-L²-X²]ₙ-L³-Y²[-L⁴-X³]ₚ-A² Formula 1a

wherein:

A¹ and A² which are the same or different, represent the remainder of the polymer backbone or terminal functional groups of the polymer;

Y¹ is the hydrophobic macromonomer segment;

Y² is the hydrophilic macromonomer segment;

X¹, X² and X³ are independently selected ionic species;

L¹, L², L³ and L⁴ are independently selected divalent linking group selected from diisocyanate, ester, carbonate and amide residues which form independently selected urethane, urethaneurea or thiocarbamate linkages with each of Y¹, Y², X¹, X² and X³; preferably L¹, L², L³ and L⁴ are independently selected divalent linking diisocyanate residues which form independently selected urethane, urethaneurea or thiocarbamate linkages;

m is an integer of 0 or 1;

n is an integer of 0 or 1; and

p is an integer of 0 or 1, wherein at least one of m, n and p is 1.

In one embodiment X1, X2 and X3 is an ionic species preferably independently selected from the group consisting of

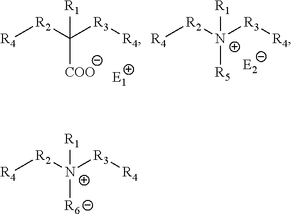

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic.
In this embodiment at least one of m, n and p is 1, preferably at least two of m, n and p are 1 such as each of m, n and p being 1.

In one embodiment, the hydrophobic segment Y1 is selected from the group consisting of poly(siloxanes), fluoropolymers, poly(butadiene)/isoprene, poly(caprolactone), poly(lactic acid), poly(3-hydroxyalkanoates), polymers derived from fatty acids, polymers derived from lignin and mixtures thereof.

In one embodiment, the hydrophilic segment Y2 is selected from the group consisting of poly(ethylene glycol), poly(saccharides), poly(vinyl alcohol), poly(glycolic acid), poly(peptides) and mixtures thereof.

In one embodiment, the copolymer segment of Formula 1 is prepared by the steps of reacting:

at least one hydrophobic macromonomer having at least two active hydrogen groups selected from hydroxyl, thiol and amine; and
at least one hydrophilic macromonomer having at least two active hydrogen groups selected from hydroxyl, thiol and amine; and
a diisocyanate.

In one embodiment, the copolymer segment of Formula 1a is prepared by the steps of reacting:

at least one hydrophobic macromonomer having at least two active hydrogen groups selected from hydroxyl, thiol and amine; and
at least one hydrophilic macromonomer having at least two active hydrogen groups selected from hydroxyl, thiol and amine; and
an ionic species; and
a diisocyanate.

In one embodiment, the copolymer segment of Formula 1a is prepared by the steps of reacting:

at least one hydrophobic macromonomer having at least two active hydrogen groups selected from hydroxyl, thiol and amine; and
a diisocyanate to form pre-polymer (1); then
reacting pre-polymer (1); and
an ionic species precursor to form pre-polymer (2); then
reacting pre-polymer (2); and
a modifying agent to modify the ionic species precursor into the ionic species; then reacting the modified pre-polymer (2); and
at least one hydrophilic macromonomer having at least two active hydrogen groups selected from hydroxyl, thiol and amine; and
a diisocyanate to form a co-polymer segment of Formula 1a.

In one embodiment, the copolymer segment of Formula 1a is prepared by the steps of reacting:

at least one hydrophilic macromonomer having at least two active hydrogen groups selected from hydroxyl, thiol and amine; and
an ionic species precursor; and
a diisocyanate to form pre-polymer (3); then
reacting pre-polymer (3); and
at least one hydrophobic macromonomer having at least two active hydrogen groups selected from hydroxyl, thiol and amine; and
a diisocyanate to form pre-polymer (4); then
reacting pre-polymer (4); and
a modifying agent to modify the ionic species precursor into the ionic species and form a co-polymer segment of Formula 1a.

In a further aspect of the present invention, there is provided an ionic hydrophobic-hydrophilic switchable polymer, the polymer comprising a copolymer segment of Formula 1b

A¹[-X¹-L¹]ₘ-Y¹[-L²-X²]ₙ-L³-Y²[-L⁴-X³]ₚ-A² Formula 1b

wherein

A¹ and A² which are the same or different, represent the remainder of the polymer backbone or terminal functional groups of the polymer;

Y¹ is a hydrophobic segment;

Y² is a hydrophilic segment;

X¹, X² and X³ are independently selected ionic species selected from the group consisting of

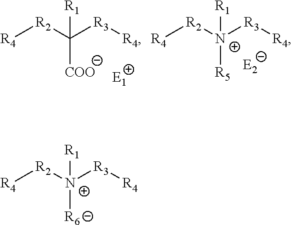

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, alkyl groups of 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic;
L¹, L², L³ and L⁴ are independently selected divalent linking groups selected from diisocyanate, ester, carbonate and amide residues which form independently selected urethane, urethaneurea or thiocarbamate linkages with each of Y¹, Y², X¹, X² and X³; preferably L¹, L², L³ and L⁴ are independently selected divalent linking diisocyanate residues which form independently selected urethane, urethaneurea or thiocarbamate linkages;
m is an integer of 0 or 1;
n is an integer of 0 or 1; and
p is an integer of 0 or 1; wherein at least one of m, n and p is 1.

### BRIEF DESCRIPTION OF DRAWINGS

Notwithstanding any other forms which may fall within the scope of the present invention, preferred embodiments of the invention will now be described, by way of example only, with reference to the accompanying drawings in which:

FIG. 1 shows the general structure of poly(ethylene glycol) diol-poly(dimethylsiloxane) diol-1,6-hexanediisocyanate (PDMS-PEG-HDI). Black bolded letters correspond to the proposed Proton Nuclear Magnetic Resonance (1H NMR) assignment.

FIG. 2 shows the structure of PDMS(0.4)-PCL(0.1)-PEG (0.5)-HDI(1). Black bolded letters correspond to the proposed 1H NMR assignment.

FIG. 3 shows the structure of the anionic polyurethane. Black bolded letters correspond to the proposed 1H NMR assignment.

FIG. 4 shows the structure of the neutral polymer. Black bolded letters correspond to the proposed 1H NMR assignment.

FIG. 5 shows the structure of the cationic polyurethane. Black bolded letters correspond to the proposed ¹H NMR assignment.

FIG. 6 shows the structure of the zwitterionic polymer. Black bolded letters correspond to the proposed ¹H NMR assignment.

FIG. 7 shows the change to water contact angle with droplet contact time on solvent-cast films of PDMS(0.5)-PEG(0.5)-HDI(1) and PDMS(0.75)-PEG(0.25)-HDI(1) over a period of 20 min.

FIG. 8 shows the water contact angles measured on melt-pressed PDMS-PEG-HDI films that were subjected to multiple cycles of hydration and drying. The water contact angles were measured after 60 s contact time with the water droplet. Hydrated samples were immersed in water for 1 h, blotted dry with paper towel and analysed immediately.

FIG. 9 shows (a) Sample peak fitting of high resolution C is spectrum obtained for PDMS(0.5)-PEG(0.5)-HDI(1). (b) Normalised, overlaid and offset C 1s spectra obtained for amphiphilic PDMS-PEG-HDI materials at two analysis depths (0-2 nm and 0-10 nm).

FIG. 10 shows the relationship between PEG content and normalised water vapour transmission rate.

FIG. 11 shows the evaporative moisture loss profile of PDMS(0.5)-PEG(0.5)-HDI(1) on sand (application rate of 55 g polymer·m⁻²) at 30° C., 40% RH. For reference, the evaporative mass loss profile of non-treated sand is shown. Error bars represent one standard deviation from the mean.

FIG. 12 shows hydrolytic degradation of PDMS-PEG-HDI materials (Examples 1-5) over 20 weeks at 50° C.

FIG. 13 is a graph showing the change in water contact angle with time over 2 min at the surface of solvent cast films of PBD(1)-HDI(1) [hydrophobic segment only], PBD(0.5)-PEG(0.5)-HDI(1) [hydrophobic and hydrophilic macromolecular segments] and COOH-modified PBD(0.5)-PEG(0.5)-HDI(1) [hydrophobic and hydrophilic macromolecular segments with carboxyl units.

FIG. 14 is a series of depictions showing the variation with time of water droplet infiltration through a polymer film, PDMS(0.5)-PEG(0.5)-HDI(1), of the invention formed on sand with a loading of 36.4 g·m⁻². The top sequence relates to polymer treated sand the middle to droplet deposition onto a wet region of film and the bottom sequence the result when the wet film is air dried and a water droplet is re-deposited.

### DETAILED DESCRIPTION

### Regulation of Water Retention

According to a first aspect of the invention, there is provided a process for regulating the water retention of soil materials used in agriculture. This process comprises applying a composition comprising a polymer to the soil materials to form a polymer film thereon. The polymer is selected from the group consisting of a urethane, urethaneurea, thiocarbamate and mixtures thereof. The polymer comprises hydrophobic and hydrophilic segments, which together provide reversible hydrophobic-hydrophilic switching whereby the film surface switches from a relatively hydrophobic state to a relatively hydrophilic state in response to the presence of water in contact with the film surface. This reversible switching of the film surface enables regulation of the water retention of the soil materials. When water is in contact with the film surface, the surface will be in a relatively hydrophilic state. The hydrophilic film surface permits the ingress of water and thus water uptake by the soil materials. Under dry conditions the film surface will be in a relatively hydrophobic state. The hydrophobic film surface reduces the amount of water that is lost from the soil materials through evaporation, compared to untreated soil materials, thus permitting water to be retained by the soil materials. The polymer film thus enables water retention of the soil materials to be regulated by allowing water uptake in wet conditions and reducing evaporation in dry conditions.

### Hydrophobic-Hydrophilic Switching

The polymers of the invention are able to undergo hydrophobic-hydrophilic switching, such that the film surface switches from a relatively hydrophobic state to a relatively hydrophilic state. This switching to the relatively hydrophilic state can be triggered in response to the presence of water in contact with the film surface. The switching is reversible, where the film surface can switch again to a relatively hydrophobic state in dry conditions. Without wishing to be bound by theory, it is believed that the hydrophobic segments have relatively low surface energy, whereas the hydrophilic segments have a higher surface energy. This difference in surface energy allows the film to restructure at the surface in response to the presence of water.

Under dry conditions the surface of the film will be in a relatively hydrophobic state. This hydrophobic film surface slows the rate of water vapour transmission from the soil materials, relative to soil with no treatment, and thus reduces the amount of water that is lost from the soil materials through evaporation under dry conditions. When the conditions change from dry to wet such that the surface of the film is in contact with water, for example due to rainfall or overhead irrigation, the film surface switches from hydrophobic to a relatively hydrophilic state, which permits the ingress of water and thus water uptake by the soil.

### Water Contact Angle

The relative hydrophobicity or hydrophilicity of a solid surface can be determined through measuring the water contact angle, which is the angle at which a liquid/vapour interface meets the solid surface. A surface is generally considered to be hydrophobic when the contact angle is >90°. A surface is generally considered to be hydrophilic when the contact angle is <90°.

When the film surface switches from a relatively hydrophobic to a relatively hydrophilic state, the water contact angle of the film surface will also change. In one embodiment, the film surface will undergo a change in water contact angle of at least 10°, preferably at least 20°, more preferably at least 25°, when switching from a relatively hydrophobic state to a relatively hydrophilic state. In one embodiment, the film surface has a water contact angle of >90° in a relatively hydrophobic state.

### Switchable Polymers

In one embodiment, the hydrophobic-hydrophilic switchable polymers of the invention are derived from the reaction product of a diisocyanate, a hydrophobic macromonomer having at least two active hydrogen groups selected from hydroxyl, thiol and amine, and a hydrophilic macromonomer having at least two active hydrogen groups selected from hydroxyl, thiol and amine.

The reaction between the macromonomers and the diisocyanate produces the urethane, urethaneurea and thiocarbamate groups of the switchable polymers, where: the reaction between a hydroxyl and an isocyanate group produces a urethane; reaction of an amine and an isocyanate group produces a urethaneurea; and the reaction of a thiol and an isocyanate produces a thiocarbamate.

The hydrophobic macromonomer provides the hydrophobic segment(s) and the hydrophilic macromonomer provides the hydrophilic segment(s) in the resulting polymer.

### Macromonomers

The hydrophobic and hydrophilic macromonomers have a molecular weight of 500-5000 g·mol-1. The macromonomers may comprise further functional groups such as carboxylic acids, aldehydes, ketones, esters, acid halides, acid anhydrides, groups, imine groups, thioesters, sulphonic acids and epoxides and mixtures thereof.

In one embodiment, the hydrophobic macromonomer is selected from the group consisting of fluoropolymers, poly(butadiene)/isoprene, poly(siloxanes), poly(caprolactone), poly(lactic acid), poly(3-hydroxyalkanoates), polymers derived from fatty acids, polymers derived from lignin and mixtures thereof. In one embodiment, the hydrophobic macromonomer is poly(dimethylsiloxane).

In one embodiment the hydrophobic macromonomer has a molecular weight selected from the group consisting of at least 500, at least 750, such as at least 1000, at least 2000, at least 3000 and at least 4000.

In one embodiment the hydrophilic macromonomer is selected from the group consisting of poly(ethylene glycol), poly(saccharides), poly(vinyl alcohol), poly(glycolic acid), poly(peptides) and mixtures thereof. In one embodiment, the hydrophilic macromonomer is poly(ethylene glycol).

In one embodiment the hydrophilic macromonomer has a molecular weight selected from the group consisting of at least 500, at least 750, such as at least 1000, at least 2000, at least 3000 and at least 4000.

In one embodiment, the hydrophobic macromonomer is poly(dimethylsiloxane) and the hydrophilic macromonomer is poly(ethylene glycol).

The molar ratio of the hydrophobic macromonomer to the hydrophilic macromonomer will be dependent on the type of hydrophobic and hydrophilic macromonomers that are selected. In one embodiment, the molar ratio of the hydrophobic macromonomer to the hydrophilic macromonomer is between about 0.05:0.95 and 0.95:0.05.

In one embodiment the hydrophobic macromonomer is poly(dimethylsiloxane) and the hydrophilic macromonomer is poly(ethylene glycol). The molar ratio of the poly(dimethylsiloxane) to the poly(ethylene glycol) is about 0.2:0.8 to 0.8:0.2, preferably about 0.5:0.5. The molecular weight of the poly(dimethylsiloxane) macromonomer is preferably about 1000 and the molecular weight of the poly(ethylene glycol) is preferably about 1000.

The hydrophobic macromonomer(s), the hydrophilic macromonomer(s) and the molar ratios of these macromonomers can be selected so as to tailor the properties of the resulting polymer film. For example, a polymer film that has a high ratio of hydrophobic segments to hydrophilic segments may undergo a greater change in water contact angle when the film switches from the relatively hydrophobic to the relatively hydrophilic state, in comparison to a polymer film where the ratios of the hydrophobic segments to the hydrophilic segments are substantially the same. The macromonomers can also be selected so as to tailor other properties of the polymer or resulting polymer film, such as dispersability in water, mechanical integrity when processed into a film and rate of biodegradation.

### Diisocyanates

The diisocyanate used in embodiments of the present invention is preferably an aliphatic diisocyanate which is conducive to providing biodegradability. Specific examples of suitable aliphatic diisocyanates include those selected from the group consisting of hexamethylene 1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, alkyl-lysine diisocyanate, dicyclohexylmethane diisocyanate, isophorone diisocyanate, 1,4-cyclohexane diisocyanate, 1,4-cyclohexane bis(methylene isocyanate), 1,3-bis(isocyanatomethyl) cyclohexane, and mixtures thereof.

### Non-Ionic Chain Extenders

In one embodiment, the polymer is derived from the reaction product of a diisocyanate, a hydrophobic macromonomer having at least two active hydrogen groups selected from hydroxyl, thiol and amine, a hydrophilic macromonomer having at least two active hydrogen groups selected from hydroxyl, thiol and amine, and optionally a non-ionic chain extender. Preferably the polymer is derived from a reaction product that comprises no more than 5 wt % of a non-ionic chain extender.

A non-ionic chain extender is a non-ionic compound that has two functional groups per molecule, such as diols or diamines, which are capable of reacting with an isocyanate group. The non-ionic chain extender may have a molecular weight range of 500 or less. In a further embodiment, the non-ionic chain extender may have a molecular weight range of about 60 to about 200. Chain extenders can provide hard segments, which are generally stiff and immobile, in the polymer. In contrast, the higher molecular weight macromonomers provide soft segments, which are generally more mobile. The presence of hard and soft segments can facilitate phase separation, which influences the elastomeric properties of the polymer.

In one embodiment, the non-ionic chain extender is a diol chain extender. Examples of diol chain extenders include, but are not limited to: C₁₋₁₂ alkane diols such as: 1,4-butanediol, 1,6-hexanediol, 1,8-octanediol, 1,9-nonanediol and 1,10-decanediol, 1,4-cyclohexane dimethanol, p-xylene glycol, 1,4-bis (2-hydroxyethoxy) benzene and 1,12-dodecanediol.

In one embodiment, the non-ionic chain extender is a diamine chain extender. Examples of diamine chain extenders include, but are not limited to: ethylene diamine (EDA), ethanolamine, butane diamine and propane diamine. Also suitable for practice in embodiments of the present invention are di-ethylenetriamine (DETA), meta-xylylene diamine (MXDA), and aminoethyl ethanolamine (AEEA), hexamethylene diamine, cyclohexylene diamine, phenylene diamine, tolylene diamine, xylene diamine, 3,3-dichlorobenzidene, 4,4-methylene-bis (2-chloroaniline), and 3,3-dichloro-4,4-diamino diphenylmethane.

In one embodiment the diisocyanate is reacted with the hydrophobic macromonomer and the hydrophilic macromonomer to form a pre-polymer. The pre-polymer is then reacted with the non-ionic chain extender to provide hard segments in the resulting polymer.

### Ionic Species

In one set of embodiments, the polymer is derived from the reaction product of a diisocyanate, a hydrophobic macromonomer having at least two active hydrogen groups selected from hydroxyl, thiol and amine, a hydrophilic macromonomer having at least two active hydrogen groups selected from hydroxyl, thiol and amine, and an ionic species. Preferably the reaction product comprises up to 15 wt % of the ionic species.

The ionic species can provide emulsifier properties which assist in polymer dispersion in water and are therefore preferably incorporated into the polymer when a stable water based polymer dispersion is desired. This allows the use of organic solvents to be minimised and assists in providing a resilient film on application to soil materials. The method of synthesis and amount of ionic species may dictate the emulsion properties such as viscosity, particle size and subsequent physico-mechanical film properties. Furthermore, the ionic species can be used to tailor properties such as adhesion, water absorption, rate of surface switching and biocompatibility of the resulting polymer films.

In one embodiment, the ionic species is selected from the group consisting of

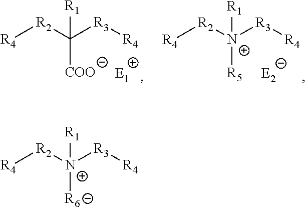

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer, and
R₅ is selected from the group consisting of hydrogen, 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic.

In one embodiment E₁ is an organic counter-ion selected from the group consisting of pyridinium, tertiary and quarternary amines.

In another embodiment E₁ is an inorganic counter-ion selected from the group consisting of monovalent cations, such as Na⁺, K⁺, Li⁺, and divalent cations, such as Ca²⁺.

In one embodiment E₂ is an organic counter-ion selected from the group consisting of carboxylates, sulfonates and phosphonates.

In another embodiment E₂ is an inorganic counter-ion selected from the group consisting of monovalent anions, such as I⁻, Cl⁻, Br⁻.

In one set of embodiments, the ionic species is

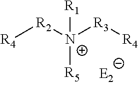

wherein R₁, R₂, R₃, R₄, R₅ and E₂ are as previously defined. Preferably, the ionic species is

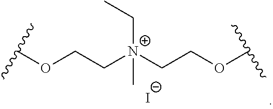 [SMILES: *OCC[N+](C)(CC)CCO* ; [I-]]

It has been found that incorporation of a cationic species in the polymer can greatly enhance the hydrophobic-hydrophilic switching in response to water.

### Molecular Weight

The polymer according to any of the above described embodiments may have a molecular weight of 30 000-200 000, preferably 50 000-120 000. Unless stated otherwise, herein the phrase “molecular weight” refers to the number-average molecular weight (Mn) of a particular polymer.

### Copolymer Segments

In one embodiment, the switchable polymer of the invention comprises a copolymer segment of Formula 1

A¹-Y¹-L-Y2-A² Formula 1

wherein
A¹ and A² which are the same or different, represent the remainder of the polymer backbone or terminal functional groups of the polymer;

Y¹ is the hydrophobic segment;

Y² is the hydrophilic segment; and

L is a divalent linking group selected from a diisocyanate, ester, carbonate and amide residues which forms independently selected urethane, urethaneurea or thiocarbamate linkages with each of Y¹ and Y²; preferably L is a divalent linking diisocyanate residue which forms independently selected urethane, urethaneurea or thiocarbamate linkages.

In one embodiment, the polymer comprises a copolymer segment of Formula 1a

A¹[-X¹-L¹]ₘ-Y¹[-L²-X²]ₙ-L³-Y²[-L⁴-X³]ₚ-A² Formula 1a

wherein
A¹ and A² which are the same or different, represent the remainder of the polymer backbone or terminal functional groups of the polymer;
Y¹ is the hydrophobic segment;
Y² is the hydrophilic segment;
X¹, X² and X³ are independently selected ionic species;
L¹, L², L³ and L⁴ are independently selected divalent linking group selected from diisocyanate, ester, carbonate and amide residues which form independently selected urethane, urethaneurea or thiocarbamatethiocarbamate linkages with each of Y¹, Y², X¹, X² and X³; preferably L¹, L², L³ and L⁴ are independently selected divalent linking diisocyanate residues which form independently selected urethane, urethaneurea or thiocarbamatethiocarbamate linkages;
m is an integer of 0 or 1;
n is an integer of 0 or 1; and
p is an integer of 0 or 1; wherein at least one of m, n and p is 1.

In one embodiment, the hydrophobic segment Y1 is selected from the group consisting of poly(siloxanes), fluoropolymers, poly(butadiene)/isoprene, poly(caprolactone), poly(lactic acid), poly(3-hydroxyalkanoates), polymers derived from fatty acids, polymers derived from lignin and mixtures thereof.

In one embodiment, the hydrophilic segment Y2 is selected from the group consisting of poly(ethylene glycol), poly(saccharides), poly(vinyl alcohol), poly(glycolic acid), poly(peptides) and mixtures thereof.

In one set of embodiments, any one of L, L1, L2, L3 and L4 is a divalent linking group selected from diisocyanate, ester, carbonate and amide residue which forms a urethane group. Urethane groups can be produced by reacting hydroxyl containing compounds, such as a diol macromonomer, with a diisocyanate or bis(chloroformate) (preferably a diisocyanate).

In one set of embodiments, any one of L, L¹, L², L³ and L⁴ is a divalent linking diisocyanate residue which forms a urethaneurea. Urethaneurea groups can be produced by reacting amine containing compounds, such as a diamine macromonomer, with a diisocyanate or bis-(chloroformate) (preferably a diisocyanate).

In one set of embodiments, any one of L, L¹, L², L³ and L⁴ is a thiocarbamate. Thiocarbamate groups can be produced by reacting thiol containing compounds, such as a dithiol macromonomers, with a diisocyanate.

The diisocyanate used in embodiments of the present invention is preferably selected from the group consisting of hexamethylene 1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, alkyl-lysine diisocyanate, dicyclohexylmethane diisocyanate, isophorone diisocyanate, 1,4-cyclohexane diisocyanate, 1,4-cyclohexane bis(methylene isocyanate), 1,3-bis(isocyanatomethyl) cyclohexane, and mixtures thereof.

The hydrophilic macromonomer thus forms the hydrophilic segment, the hydrophobic macromonomer forms the hydrophobic segment and the diisocyanate forms the divalent linking residue in the resulting co-polymer segment of Formula 1 or Formula 1a.

In one set of embodiments, X¹, X² and X³ are independently selected from the group consisting of

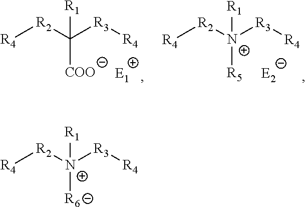

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of alkyl groups of hydrogen, 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic.

In this embodiment at least one of m, n and p is 1, preferably at least two of m, n and p are 1 such as each of m, n and p being 1.

In one embodiment E₁ is an organic counter-ion selected from the group consisting of pyridinium, tertiary and quarternary amines.

In another embodiment E₁ is an inorganic counter-ion selected from the group consisting of monovalent cations, such as Na⁺, K⁺, Li⁺, and divalent cations, such as Ca²⁺.

In one embodiment E₂ is an organic counter-ion selected from the group consisting of carboxylates and sulfonates.

In another embodiment E₂ is an inorganic counter-ion selected from the group consisting of monovalent anions, such as I⁻, Cl⁻, Br⁻.

In one set of embodiments, at least one of X¹, X² and X³ is

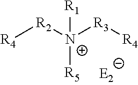

wherein R₁, R₂, R₃, R₄, R₅ and E₂ are as previously defined. Preferably, at least one of X¹, X² and X³ is

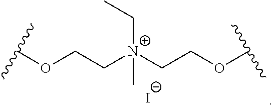 [SMILES: *OCC[N+](C)(CC)CCO* ; [I-]]

### Preparation of Co-Polymer Segments

In one embodiment, the copolymer segment of Formula 1 is prepared by the steps of reacting:

at least one hydrophobic macromonomer having at least two active hydrogen groups selected from hydroxyl, thiol and amine; and
at least one hydrophilic macromonomer having at least two active hydrogen groups selected from hydroxyl, thiol and amine; with
a diisocyanate.

In one embodiment, the copolymer segment of Formula 1a is prepared by the steps of reacting:

at least one hydrophobic macromonomer having at least two active hydrogen groups selected from hydroxyl, thiol and amine; and
at least one hydrophilic macromonomer having at least two active hydrogen groups selected from hydroxyl, thiol and amine; and
an ionic species; with
a diisocyanate. The copolymer segment may also be prepared by reaction of hydrophobic and hydrophilic macromolecular segments with either bis(chloroformate) or diamine termini and either a bis(chloroformate) or diamine terminated small molecule to generate a poly(urethane). In a further embodiment the copolymer segment may be formed by reaction of hydrophobic and hydrophilic macromolecular segments with either dicyclic carbonate or aliphatic diamine termini and either a dicyclic carbonate or aliphatic diamine small molecule to generate a poly(hydroxy-urethane). In this embodiment the polymer of formula 1, 1a and 1b comprise linking groups (L1, L2, L3 and L4 which are ester, carbonate or amide residues).

In one embodiment, the copolymer segment of Formula 1a is prepared by the steps of reacting:

at least one hydrophobic macromonomer having at least two active hydrogen groups selected from hydroxyl, thiol and amine; and
a diisocyanate to form pre-polymer (1); then
reacting pre-polymer (1); and
an ionic species precursor to form pre-polymer (2); then
reacting pre-polymer (2); and
a modifying agent to modify the ionic species precursor into the ionic species; then reacting the modified pre-polymer (2); and
at least one hydrophilic macromonomer having at least two active hydrogen groups selected from hydroxyl, thiol and amine; and
a diisocyanate to form a co-polymer segment of Formula 1a.

For example, in one embodiment the hydrophobic macromonomer is poly(dimethylsiloxane) diol and the diisocyanate is 1,6-hexanediisocyanate, which are reacted to form pre-polymer (1). Pre-polymer (1) is then reacted with the ionic species precursor bis-hydroxymethylpropanoic acid to form pre-polymer (2). Pre-polymer (2) is then modified with triethylamine to modify the ionic species precursor into the ionic species. This modified pre-polymer (2) is then reacted with the hydrophilic macromonomer, poly(ethylene glycol) diol, and 1,6-hexanediisocyanate to form a co-polymer segment of Formula 1a. In this embodiment the co-polymer segment of Formula 1a is anionic.

In one embodiment, the copolymer segment of Formula 1a is prepared by the steps of reacting:

at least one hydrophilic macromonomer having at least two active hydrogen groups selected from hydroxyl, thiol and amine; and
an ionic species precursor; and
a diisocyanate to form pre-polymer (3); then
reacting pre-polymer (3); and
at least one hydrophobic macromonomer having at least two active hydrogen groups selected from hydroxyl, thiol and amine; and
a diisocyanate to form pre-polymer (4); then
reacting pre-polymer (4); and
a modifying agent to modify the ionic species precursor into the ionic species and form a co-polymer segment of Formula 1a.

For example, in one embodiment the hydrophilic macromonomer is poly(ethylene glycol) diol, the ionic species precursor is N-ethyldiethanolamine and the diisocyanate is 1,6-hexanediisocyanate, which are reacted to form pre-polymer (3). Pre-polymer (3) is then reacted with the hydrophobic macromonomer, poly(dimethylsiloxane) diol, and 1,6-hexanediisocyanate to form pre-polymer (4). Pre-polymer (4) is then reacted with a modifying agent to modify the ionic species precursor into the ionic species and form a co-polymer segment of Formula 1a. In one embodiment the modifying agent is iodomethane and the resulting co-polymer segment of Formula 1a is cationic. In another embodiment the modifying agent is 1,3-propanesultone and the resulting co-polymer segment of Formula 1a is zwitterionic.

### Ionic Hydrophobic-Hydrophilic Switchable Polymer

In a further aspect of the present invention, there is provided an ionic hydrophobic-hydrophilic switchable polymer, the polymer comprising a copolymer segment of Formula 1b

A¹[-X¹-L¹]ₘ-Y¹[-L²-X²]ₙ-L³-Y²[-L⁴-X³]ₚ-A² Formula 1b

wherein

A¹ and A² which are the same or different, represent the remainder of the polymer backbone or terminal functional groups of the polymer;

Y¹ is a hydrophobic segment;

Y² is a hydrophilic segment;

X¹, X² and X³ are independently selected ionic species selected from the group consisting of

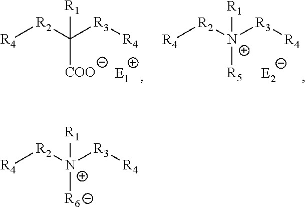

and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, alkyl groups of 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic;
L¹, L², L³ and L⁴ are independently selected divalent linking groups selected from diisocyanate, ester, carbonate and amide residues which form independently selected urethane, urethaneurea or thiocarbamate linkages with each of Y¹, Y², X¹, X² and X³;
m is an integer of 0 or 1;
n is an integer of 0 or 1; and
p is an integer of 0 or 1; wherein at least one of m, n and p is 1;

preferably L¹, L², L³ and L⁴ are independently selected divalent linking groups selected from diisocyanate, ester, carbonate and amide residues which form independently selected urethane, urethaneurea or thiocarbamate linkages.

The carboxylic sulfonates and phosphonates which may be present in the polymer are generally pendent to the polymer backbone.

In one embodiment, the hydrophobic segment Y1 is selected from the group consisting of poly(siloxanes), fluoropolymers, poly(butadiene)/isoprene, poly(caprolactone), poly(lactic acid), poly(3-hydroxyalkanoates), polymers derived from fatty acids, polymers derived from lignin and mixtures thereof.

In one embodiment, the hydrophilic segment Y2 is selected from the group consisting of poly(ethylene glycol), poly(saccharides), poly(vinyl alcohol), poly(glycolic acid), poly(peptides) and mixtures thereof.

In one set of embodiments, any one of L, L1, L2, L3 and L4 is a divalent linking diisocyanate residue which forms a urethane group. Urethane groups can be produced by reacting hydroxyl containing compounds, such as a diol macromonomer, with a diisocyanate.

In one set of embodiments, any one of L, L¹, L², L3 and L⁴ is a divalent linking diisocyanate residue which forms a urethaneurea. Urethaneurea groups can be produced by reacting amine containing compounds, such as a diamine macromonomer, with a diisocyanate.

In one set of embodiments, any one of L, L¹, L², L³ and L⁴ is a thiocarbamate. Thiocarbamate groups can be produced by reacting thiol containing compounds, such as a dithiol macromonomers, with a diisocyanate.

The diisocyanate is preferably selected from the group consisting of hexamethylene 1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, alkyl-lysine diisocyanate, dicyclohexylmethane diisocyanate, isophorone diisocyanate, 1,4-cyclohexane diisocyanate, 1,4-cyclohexane bis(methylene isocyanate), 1,3-bis(isocyanatomethyl) cyclohexane, and mixtures thereof.

In one embodiment E₁ is an organic counter-ion selected from the group consisting of pyridinium, tertiary and quarternary amines.

In another embodiment E₁ is an inorganic counter-ion selected from the group consisting of monovalent cations, such as Na⁺, K⁺, Li⁺, and divalent cations, such as Ca²⁺.

In one embodiment E₂ is an organic counter-ion selected from the group consisting of carboxylates and sulfonates.

In another embodiment E₂ is an inorganic counter-ion selected from the group consisting of monovalent anions, such as I⁻, Cl⁻, Br⁻.

In one set of embodiments, at least one of X¹, X² and X³ is

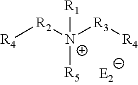

wherein R₁, R₂, R₃, R₄, R₅ and E₂ are as previously defined. Preferably, at least one of X¹, X² and X³ is

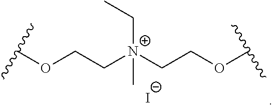 [SMILES: *OCC[N+](C)(CC)CCO* ; [I-]]

### Polymer Composition

In one embodiment, the composition comprising the switchable polymer is provided as an aqueous dispersion. Preferably, the polymer is present in an amount of from 1 to 60 wt % of the aqueous dispersion. The dispersion may be applied to a surface area of soil or may be applied below the soil surface. The dispersion may be applied to soil materials prior to planting of seeds or plants or after planting of seeds or plants. It may be preferred in the case of seeds that the dispersion be applied after seed placement to reduce loss of seeds. In one set of embodiments the dispersion is provided in the form of a concentrate for dilution prior to application to soil by, for example spraying onto soil. In one set of embodiments the dispersion applied to soil comprises the polymer in a concentration in the range of from 1 wt % to 15 wt % such as from 1 wt % to 10 wt % or 1 wt % to 5 wt % of an aqueous dispersion. It is believed that the application of a relatively dilute solution of 1 to 5 wt % polymer of an aqueous dispersion will significantly improve water retention of the soil.

The aqueous dispersion can be applied onto the soil materials by spray application, using spray equipment commonly used in agriculture in applying crop protection compositions. In one embodiment, the dispersion is applied to soil materials at a rate of about 0.5 kg to about 1.0 kg per square meter of soil materials. The aqueous dispersion may be applied in a single or multiple applications such as one, two or three spray applications to the same area of soil. In particularly absorbent soils such as sandy soils, the aqueous dispersion may be drawn into the soil and form a less effective film. In such cases, multiple applications may be useful. In one set of embodiments, which may be particularly useful in sandy soils, the dispersion is applied following application of a primer adapted to reduce wicking of the polymer into the soil. Useful primer layers may include one or more materials selected from the group consisting of anionic polysaccharides such as alginate salts.

In one embodiment, the aqueous dispersion is applied onto the soil materials using farming equipment such as machinery used in tillage and seeding of commercial food crops. The aqueous dispersion may be deployed before seed, together with seed or after seed. It may be contacted with seeds during or after the deployment of seeds. Alternatively, the aqueous dispersion may be applied to soil adjacent, such as directly covering the placed seeds, using a combination mechanical seeder which may be, for example, a gravity or pneumatically fed seeder The aqueous dispersion may be applied using an applicator attached to co-operate with a tilling implement to provide a film above and adjacent the placed seed. In one embodiment, the seed and aqueous dispersion are each contained in separate tanks each connected to feeder conduits for delivering contents to separate outlets behind the tilling implement. The seed delivery conduit delivers seed behind the tilling implement as the tilling implement moves forward to create a furrow in the ground surface. The seed emerging from the conduit outlet is deposited into the furrow. Gravity and/or a cooperating roller wheel may cause the furrow to collapse to a certain extent and the aqueous dispersion outlet to the rear of seed outlet may deposit the aqueous dispersion over the seed or the soil covering adjacent to the seed.

In a further embodiment, the aqueous dispersion is applied to an area of soil prepared for crops such as vegetables. Seedlings or seeds are then planted into this soil to which the aqueous dispersion has been applied.

In another embodiment, the composition comprising the switchable polymer is provided as a pre-cured film. Pre-cured films of the switchable polymer can be prepared by methods such as compression moulding, solvent casting, spin casting and extrusion.

### Additives

In one embodiment, the composition comprising the switchable polymer further comprises one or more additives. The additives are selected from the group consisting of fillers, thickeners, agrochemicals and surfactants. The additive may be sorbed onto pre-cured polymer films or may be added during or after the preparation of an aqueous dispersion of the polymer composition. The amount of additive is selected such that the hydrophobic-hydrophilic switching properties of the polymer are not adversely affected.

In one embodiment, the composition comprises fillers. These fillers may be hydrophobic or hydrophilic.

The hydrophobic fillers are selected from the group consisting of charcoal, graphene, talc, hydrophobic clays, organo-substituted silicas, organo-substituted cellulose and mixtures thereof. Without wishing to be bound by theory, it is believed that the incorporation of hydrophobic fillers will increase the maximum achievable water contact angle of the film in the dry state.

The hydrophilic fillers are selected from the group consisting of silicates, humates, phosphates, starch, micro/nano-crystalline cellulose, acid-functionalised micro/nano-crystalline cellulose, hydrophilic clays and mixtures thereof. It is believed that the incorporation of hydrophilic fillers will decrease the water contact angle of the film when in contact with water. Furthermore, the hydrophilic fillers may assist in miscibility with water and also increase the viscosity.

In one embodiment, the hydrophilic filler is potassium humate. Potassium humates are available commercially including K-HUMATE S-90® (available from Omnia Specialties Australia Pty Ltd). In one set of embodiments, the weight ratio of polymer to filler is in the range of from 1:0.01 to 1:0.1. The use of a humate provides a black film on application to soil which is useful in increasing the temperature of the soil and promoting plant growth. Humates also have properties as fertiliser and plant growth stimulant and on degradation of the film provide soil conditioning.

In one embodiment, the hydrophilic filler is a silicate exemplified by the Cab-O-Sil® M-5 product available from Multichem Pty Ltd. The silicate filler is preferably used in a weight ratio of polymer to filler in the range from 1:0.01 to 1:0.1. When the polymer composition is in the form of an aqueous dispersion, the surface silanol groups can provide miscibility with water and also increase the viscosity.

In one embodiment, the composition comprises thickeners. Thickeners can modify the viscosity and increase the hydrophilic properties when the polymer composition is in the form of an aqueous dispersion. In one set of embodiments, the composition comprises thickeners selected from the group consisting of biopolymeric compounds such as gelatine, alginate, wood meal, xanthan gum and polyacrylamide (PAM), cellulose and carboxymethyl cellulose. These materials can be blended with the polymer in an aqueous dispersion in different wt % ratios which range from 1 to 10 wt %, preferably 1-5 wt % and most preferably between 1-2 wt %. In a preferred set of embodiments, the viscosity of the aqueous dispersion is no more than 50 to 100 mPa·s and in a preferred set of embodiments, the viscosity is in the range of from 5 to 50 mPa·s.

In one embodiment, the composition comprises agrochemicals. Examples of suitable agrochemicals include pesticides, plant growth regulators, plant nutrients and fertilizers. The incorporation of such agrochemicals may allow their controlled release to the soil or immediate growing environment of the plants from the polymer film during crop production.

Pesticides may include one or more selected from the group consisting of herbicides, insecticides, fungicides, nematodicides and molluscicides.

Examples of herbicides which may be included may be selected from the group consisting of FOPs, DIMs, sulfonyl ureas, synthetic auxins, dinitroanilines and quinolone carboxylic acids.

Examples of insecticides include carbamates, triazemates, organophosphates, cyclodiene organochlorines, fiproles, methoxychlor, pyrethroids, pyrethrins, neonicotinoids, nicotine, spinosyns, Bacillus thuringiensis (Bt), benzoylureas and the like.

Examples of fungicides include metalaxyl, mefenoxam, azoxystrobin captan, thiabendazole, fludiaxonil, thiram, pentachloronitrobenzene (PCNB), potassium bicarbonate, copper fungicides and Bacillus subtilis.

Examples of nematodicides include avermectins, carbamates, oxime carbamates, organophosphorus nematodicides.

In one embodiment, the composition comprises a surfactant. Surfactants can assist in dispersing the polymer when the polymer composition is in the form of an aqueous dispersion. Surfactants also enhance the stability of the dispersion. The surfactant may be anionic, cationic, zwitterionic or non-ionic. The surfactant is preferably biodegradable. Examples of suitable surfactants include sodium dodecyl sulfate (SDS), Dodecyltrimethylammonium bromide (DTAB) and alkyl sulfonates. Typically, a surfactant would be employed when the switchable polymer does not comprise an ionic species and is relatively hydrophobic.

### Film Biodegradability

Unlike plastic mulches, the polymer films formed in accordance with the present invention are generally biodegradable. The rate of biodegradation of the films may be controlled by the selection of the macromonomers and diisocyanates within the polymer. In general, the biodegradability will be dependent on the type and proportion of macromonomer(s) used. In addition, polymers derived from asymmetric aliphatic diisocyanates are generally degraded faster than those derived from symmetrical aliphatic or aromatic diisocyanates. This combination of factors may be used to tailor the rate of degradation of the polymer so as to match the period of effective film required.

In some cases, a film may be required only during establishment of crops over a relatively short period of two or three months. In other situations, the film may be required for a more prolonged growing period in which case a lower rate of biodegradation is preferred.

The biodegradability of polymers in soil is generally measured by monitoring the peak intensity of functional groups in the degraded film by IR, mass loss or molecular weight loss (Annals of Microbiology, 58 (3) 381-386 (2008) or by measuring the CO2 emission from the soil under controlled conditions during degradation (Muller et al., 1992), Chemical Engineering Journal 142 (2008) 65-77.

The invention will now be described with reference to the following examples. It is to be understood that the examples are provided by way of illustration of the invention and that they are in no way limiting to the scope of the invention.

### EXAMPLES

### Reagents

Poly(ethylene glycol) diol (PEG, molecular weight (MW): 1020 g·mole⁻¹), poly(dimethylsiloxane) diol (PDMS, MW: 928.3 g·mole⁻¹), poly(dimethylsiloxane) diol (PDMS₂₀₀₀ MW: 1889.8 g·mole⁻¹), poly(ε-caprolactone) diol (PCL, MW: 963.1 g·mole⁻¹), poly(butadiene) diol (PBD, MW: 1,506.0 g·mole⁻¹) were dried at 80-90° C. under vacuum (3×10⁻³ torr) until the moisture content was less than 0.01% (as measured by Karl Fisher titration) 1,6-hexanediisocyanate (HDI), N,N-dimethylacetamide (DMAc, anhydrous), dibutyl tin dilaurate (DBTDL), N-ethyldiethanolamine (NEt[EtOH]₂), bis-hydroxymethylpropanoic acid (BHMPA), titanium dioxide (TiO₂, aeroxide P25), dried tetrahydrofuran containing 0.05% BHT as inhibitor (THF), 3-mercaptopropanoic acid (MPA) were used as received. Synthesised polymers were characterised by the following methods.

### Polymer Characterisation

Proton Nuclear Magnetic Resonance (¹H NMR) spectra were recorded at 400 MHz with a Bruker DPX-400 spectrometer. The NMR spectra refer to solutions in deuterated chloroform (CDCl3), where the solvent signals were used as internal standards. Resonance peaks were assigned according to the following convention: chemical shift measured in part per million (ppm) relative to the solvent, multiplicity, coupling constants (J Hz), number of protons, and assignments. Multiplicities are denoted as s (singlet), d (doublet), dd (doublet of doublets), t (triplet), dt (doublet of triplets), td (triplet of doublets), q (quartet) or m (multiplet).

Gel permeation chromatography (GPC) was performed on a Shimadzu system equipped with a CMB-20A controller system, an SIL-20A HT autosampler, an LC-20AT tandem pump system, a DGU-20A degasser unit, a CTO-20AC column oven, an RDI-10A refractive index detector, and 4× Waters Styragel columns (HT2, HT3, HT4, and HT5, each 300 mm×7.8 mm², providing an effective molar mass range of 100-4×10⁶). N,N-Dimethylacetamide (DMAc) (containing 4.34 g L⁻¹ lithium bromide (LiBr)) was used as an eluent with a flow rate of 1 mL/min at 80° C. Number (Mₙ) and weight average (M_{w}) molar masses were evaluated using Shimadzu LC Solution software. The GPC columns were calibrated with low dispersity polystyrene (PSt) standards (Polymer Laboratories) ranging from 575 to 3,242,000 g mol⁻¹, and molar masses are reported as PSt equivalents. A 3rd-order polynomial was used to fit the log Mₚ vs. time calibration curve, which was nearly linear across the range of molar masses.

Fourier transform infrared (FTIR) spectra were collected on a Perkin Elmer Spectrum 2000 FTIR instrument in attenuated total reflectance (ATR) mode using diamond as the background reference. The infrared data were recorded in wavenumbers (cm⁻¹) with the intensity of the absorption (vmax) specified as either strong (s), medium (m), weak (w) and prefixed broad (b) where appropriate.

The thermal transitions of the materials were measured by differential scanning calorimetry (DSC) using a Mettler DSC 30. Approximately 8 mg of polymer was encapsulated in a pierced 40 μL aluminium pan. The sample was heated (under nitrogen, 25 mL·min⁻¹) from 25 to 60° C. at a rate of 10° C.·min⁻¹, held at 60° C. for 1 min, cooled to −50° C. (−10° C.·min⁻¹) and held for 1 min to remove the thermal history of the materials. Finally, the samples were heated from −50 to 200° C. at a rate of 10° C.·min⁻¹. The crystallisation temperature (T_{c}) was identified in the cooling cycle, while the glass transition temperature and melting temperatures (T_{g} and Tₘ, respectively) were measured in the final heating cycle.

### Synthesis of Non-Ionic Polyurethanes

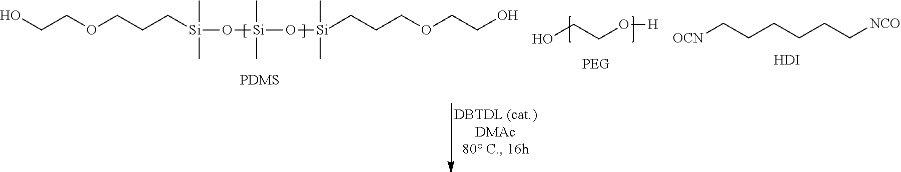

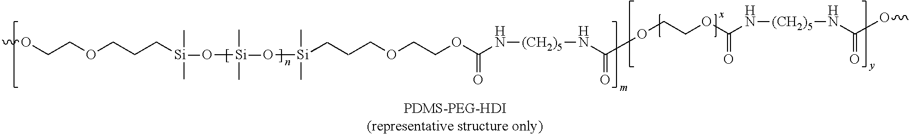

| | m | y |
|---|---|---|
| PEG(1)-HDI(1) | 0 | 1 |
| PDMS(0.25)-PEG(0.75)-HDI(1) | 0.25 | 0.75 |
| PDMS(0.5)-PEG(0.5)-HDI(1) | 0.5 | 0.5 |
| PDMS(0.75)-PEG(0.25)-HDI(1) | 0.75 | 0.25 |
| PDMS(1)-HDI(1) | 1 | 0 |

Scheme 1

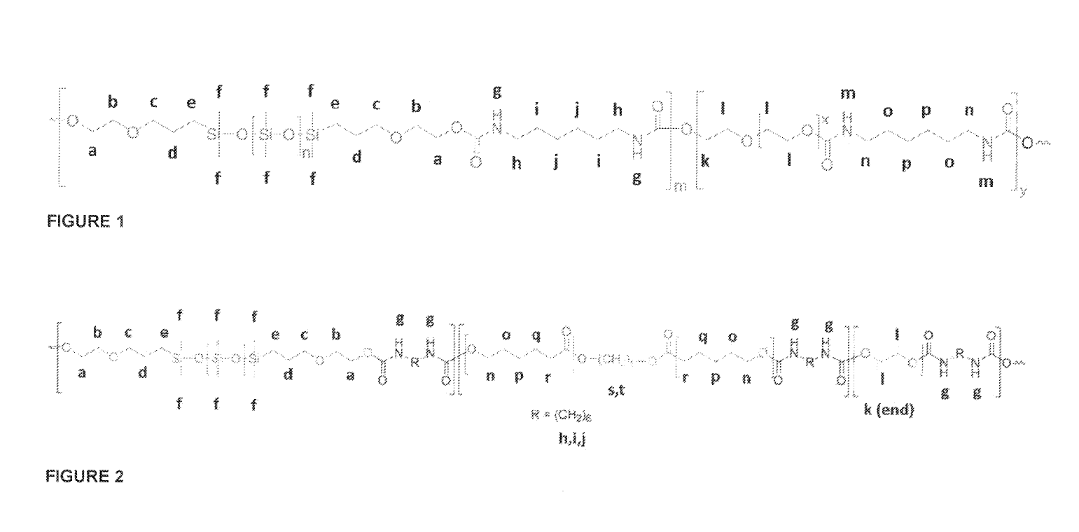

Synthesis of urethane-linked PDMS-PEG-HDI materials. The molar ratio of hydrophobic and hydrophilic repeat segments in the polymers are denoted with m and y, respectively. Dimethyisiloxane and ethylene glycol repeat units are denoted with n and x, respectively. The general structure of PDMS-PEG-HDI is shown in FIG. 1.

### Example 1

### Synthesis of Non-Ionic PEG(1)-HDI(1)

PEG (25.57 g, 25.1 mmole) was weighed via syringe into a dry, N₂-purged, round bottom flask equipped with magnetic stirrer and subaseal and was dissolved in DMAc at 80° C. under a constant flow of N₂ to give a concentration of 0.4 g polyol·mL⁻¹. DBTDL catalyst (0.1 wt %) was added, and the mixture was allowed to stir for 5 min. HDI (4.217 g, 25.1 mmole) was added in one-portion via syringe and the mixture was polymerised at 80° C. for 16 h. The reaction mixture was decanted into rectangular Teflon dishes (14.5×7.5×1 cm) and the solvent was evaporated in vacuo (50° C., 50 mbar, 16 h) to give polymer sheets suitable for further characterisation and processing.

Characterisation:

¹H NMR: (400 MHz, CDCl₃) δ 1.31 (br. m, 4H, p), 1.46 (br. m, 4H, o), 3.13 (q, J=6.7 Hz, 4H, n), 3.62 (s, 92H, l), 4.18 (t, J=7.1 Hz, 4H, k), 4.88 (br. s, 2H, m). IR(ATR): 3330 w, 2881 m, 1715 m, 1536 m, 1465 m, 1343 m, 1278 m, 1240 m, 1145 sh. m, 1103 s, 1060 sh. m, 961 m, 947 m, 841 m, 777 w cm⁻¹. GPC(DMAc+LiBr): Mₙ 76,300, M_{w}/M_{w} 1.91. DSC: T_{g} not observed; T_{c} 18° C. (55.8 J·g⁻¹); Tₘ 33.7° C., −58.0 J·g⁻¹.

### Example 2

### Synthesis of Non-Ionic PDMS(0.25)-PEG(0.75)-HDI(1)

The polymer was prepared using a similar method to that given in Example 1, except the following quantities of precursors were used: PDMS diol (7.0712 g, 7.62 mmole) PEG diol (23.3104 g, 22.9 mmole) and HDI (5.1249 g, 30.5 mmole).

Characterisation:

¹H NMR: (400 MHz, CDCl₃) δ 0.04-0.08 (br, 15H, f), 0.48 (m, 1H, e), 1.29 (br. m, 4H, j/p), 1.46 (br. m, 4H, i/o), 1.57 (m, 1H, d), 3.13 (q, J=6.7 Hz, 4H, h/n), 3.41 (t, J=7.1 Hz, 1H, c), 3.61 (s, 69H, b/l), 4.18 (t, J=7.1 Hz, 4H, a/k), 4.80 and 4.89 (2×br. s, 2H, g/m) IR(ATR): 3333 w, 2881 m, 1716 m, 1535 m, 1465 m, 1343 m, 1278 sh. m, 1241 m, 1145 sh. m, 1103 s, 962 m, 841 m, 777 w cm⁻¹. GPC(DMAc+LiBr): Mₙ 75,300, M_{w}/Mₙ 1.86. DSC: T_{g}−11.2° C.; T_{c}−11.3° C., 41.9 J·g⁻¹; Tₘ 28.4° C., −43.7 J·g⁻¹.

### Example 3

### Synthesis of Non-Ionic PDMS(0.5)-PEG(0.5)-HDI(1)

The polymer was prepared using a similar method to that given in Example 1, except the following quantities of precursors were used: PDMS diol (13.4168 g, 14.5 mmole), PEG diol (14.7429 g, 14.5 mole) and HDI (4.8620 g, 28.9 mmole).

Characterisation:

¹H NMR: (400 MHz, CDCl₃) δ 0.04-0.08 (br, 29H, f), 0.48 (m, 2H, e), 1.29 (br. m, 4H, j/p), 1.46 (br. m, 4H, i/o), 1.57 (m, 2H, d), 3.13 (q, J=6.7 Hz, 4H, h/n), 3.41 (t, J=7.1 Hz, 2H, c), 3.61 (s, 46H, b/l), 4.18 (t, J=7.1 Hz, 4H, a/k), 4.80 and 4.89 (2×br. s, 2H, g/m). IR(ATR): 3339 w, 2956 w, 2924 w, 2866 m, 1717 m, 1536 m, 1465 m, 1344 m, 1257 s, 1090 s, 1018 s, 963 m, 839 w, 794 s, 703 w cm⁻¹. GPC(DMAc+LiBr): Mₙ 80,300, M_{w}/Mₙ 1.61. DSC: T_{g}−13.9° C.; T_{c}−11.3° C., 25.9 J·g⁻¹; Tₘ 23.8° C., −26.9 J·g⁻¹.

### Example 4

### Synthesis of Non-Ionic PDMS(0.75)-PEG(0.25)-HDI(1)

The polymer was prepared using a similar method to that given in Example 1, except the following quantities of precursors were used: PDMS diol (22.6875 g, 24.4 mmole), PEG diol (8.3100 g, 8.15 mole) and HDI (5.4810 g, 32.6 mmole).

Characterisation:

¹H NMR: (400 MHz, CDCl₃) δ 0.04-0.08 (br, 42H, f), 0.48 (m, 3H, e), 1.29 (br. m, 4H, j/p), 1.46 (br. m, 4H, i/o), 1.57 (m, 3H, d), 3.13 (q, J=6.7 Hz, 4H, h/n), 3.41 (t, J=7.1 Hz, 3H, c), 3.61 (s, 23H, b/l), 4.18 (t, J=7.1 Hz, 4H, a/k), 4.80 and 4.89 (2×br. s, 2H, g/m). IR(ATR): 3338 w, 2960 m, 2864 m, 1718 m, 1625 w, 1533 m, 1458 w, 1349 w, 1257 s, 1082 s, 1015 s, 792 s, 702 m cm⁻¹. GPC(DMAc+LiBr): Mₙ 112,900, M_{w}/Mₙ 1.98. DSC: T_{g}−21.5° C.; T_{c}−24.4° C., 9.8 J·g⁻¹; Tₘ 14.9, 22.1° C., −11.7 J·g⁻¹.

### Example 5

### Synthesis of Non-Ionic PDMS(1)-HDI(1)

The polymer was prepared using a similar method to that given in Example 1, except the following quantities of precursors were used: PDMS diol (22.6754 g, 24.4 mmole) and HDI (4.1086 g, 24.4 mmole).

Characterisation:

¹H NMR: (400 MHz, CDCl₃) δ 0.04-0.08 (br, 58H, f), 0.53 (m, 4H, e), 1.32 (br. m, 4H, j), 1.48 (br. m, 4H, i), 1.61 (m, 4H, d), 3.14 (q, J=6.6 Hz, 4H, h), 3.41 (t, J=7.1 Hz, 4H, c) 3.60 (t, J=4.6 Hz, 4H, b), 4.20 (t, J=4.5 Hz, 4H, a), 4.78 (br. s, 2H, g). Selected IR(ATR): 3338 w, 2960 w, 2936 w, 2857 w, 1716 m, 1533 m, 1442 w, 1412 w, 1256 s, 1014 s, 790 s, 702 m cm⁻¹. GPC(DMAc+LiBr): Mₙ 67,600, M_{w}/Mₙ 1.47. DSC: T_{g}−24.1° C., T_{c} and Tₘ were not observed.

### Synthesis of Additional Non-Ionic Polyurethanes

### Example 6

### Synthesis of Non-Ionic PDMS(0.4)-PCL(0.1)-PEG (0.5)-HDI(1)

The polymer was prepared using a similar method to that given in Example 1, except the following quantities of precursors were used: PDMS diol (4.2165 g, 4.54 mmole), PCL diol (1.0936 g, 1.14 mmole), PEG diol (5.7913 g, 5.68 mmole) and HDI (1.9099 g, 11.6 mmole). The Structure and proposed ¹H NMR assignment of PDMS(0.4)-PCL(0.1)-PEG (0.5)-HDI(1) is shown in FIG. 2.

Characterisation:

¹H NMR: (400 MHz, CDCl₃) δ 0.04-0.08 (br, 47H, f), 0.53 (m, 3H, e), 1.32 (br. m, 8H, j), 1.38 (br. m, 3H, p), 1.48 (br. m, 8H, i), 1.63 (m, 10H, d/q/o/t), 2.30 (br. m, 3H, r), 3.14 (q, J=6.6 Hz, 8H, h), 3.41 (t, J=7.1 Hz, 3H, c) 3.63 (s, 92H, l/b), 4.06 (br. m, 3H, n/s), 4.20 (br. m, 7H, a/k), 4.81/4.91 (br. s, 4H, g). GPC(DMAc+LiBr): Mₙ 66,100, M_{w}/Mₙ 1.53.

### Example 7

### Synthesis of Non-Ionic PDMS₂₀₀₀(0.25)-PEG(0.75)-HDI(1)

The polymer was prepared using a similar method to that given in Example 1, except the following quantities of precursors were used: PDMS₂₀₀₀ diol (3.6015 g, 1.91 mmole), PEG diol (5.8317 g, 5.72 mmole) and HDI (1.2821 g, 7.62 mmole). ¹H NMR assignments correspond with those given in FIG. 1.

Characterisation:

¹H NMR: (400 MHz, CDCl₃) δ 0.04-0.08 (br, 66H, f), 0.52 (m, 2H, e), 1.29 (br. m, 8H, j/p), 1.46 (br. m, 8H, i/o), 1.57 (m, 2H, d), 3.14 (q, J=6.7 Hz, 8H, h/n), 3.42 (t, J=7.1 Hz, 2H, c), 3.61 (s, 129H, b/l), 4.20 (t, J=7.1 Hz, 8H, a/k), 4.91 (2×br. s, 4H, g/m). GPC(DMAc+LiBr): Mₙ 61,200, M_{w}/Mₙ 1.74.

### Synthesis of Ionic Polyurethanes

### Example 8

### Synthesis of Anionic PDMS(1)-BHMPA(2)-PEG(1)-HDI(4)

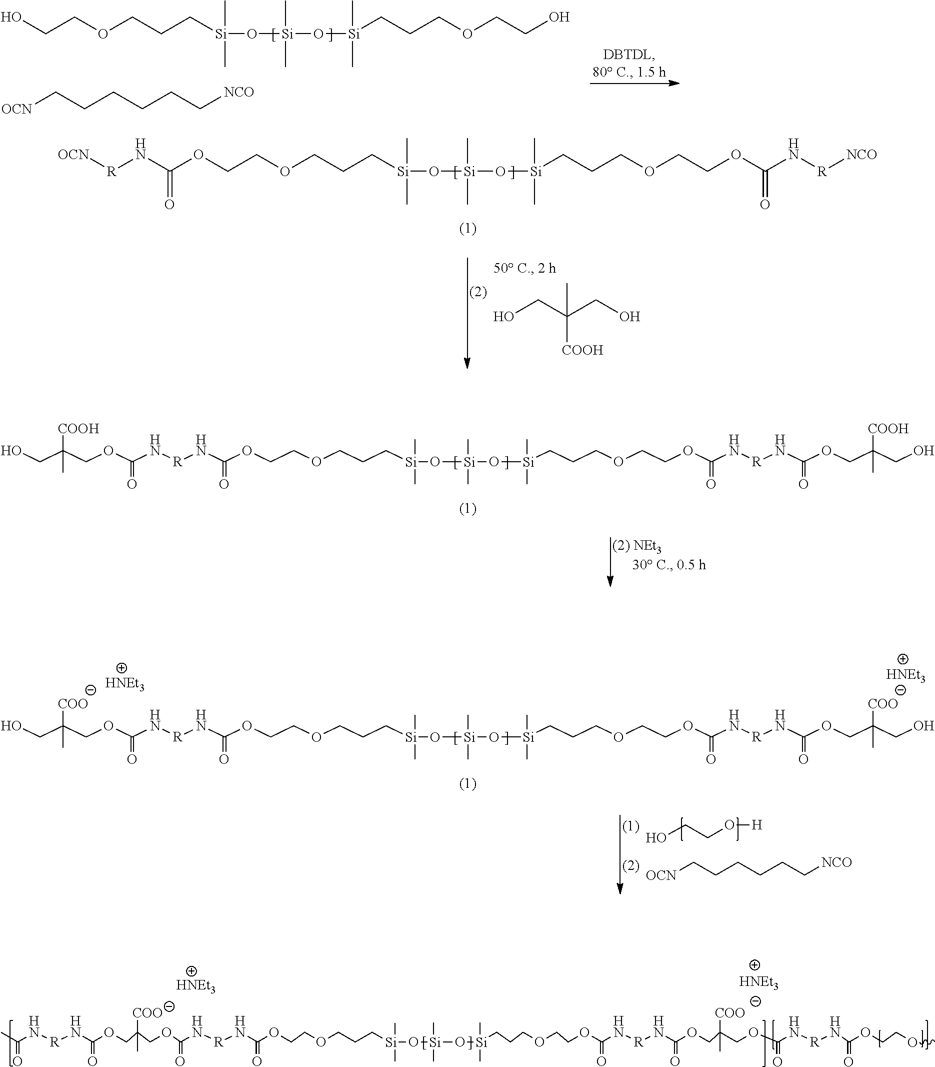

Scheme 2 Synthesis of Anionic Polyurethane

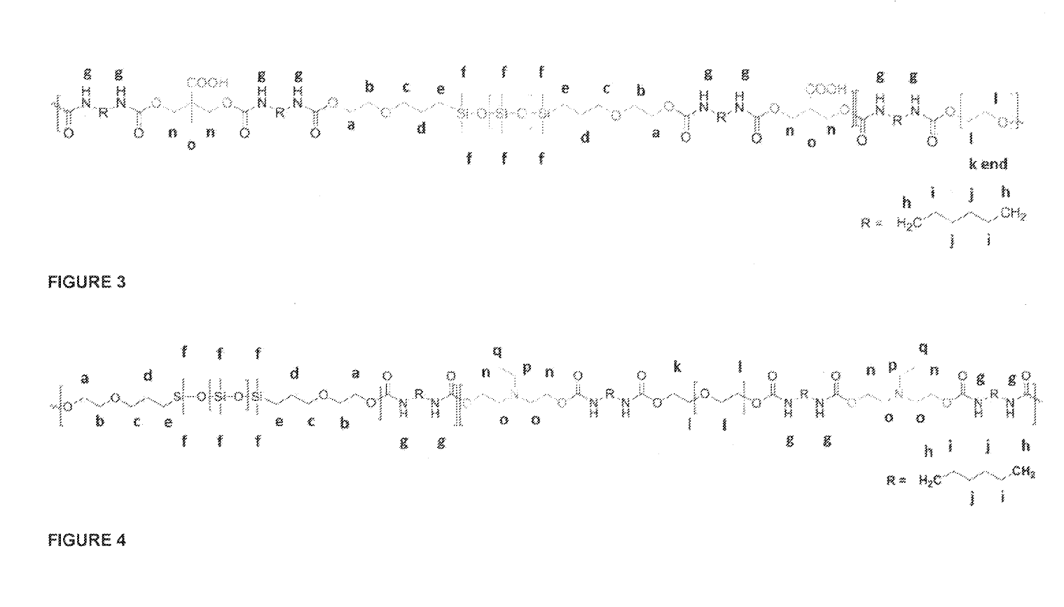

PDMS diol (4.5778 g 4.93 mmole) was added in one portion to HDI (1.6588 g, 9.86 mmole). DBTDL catalyst was added, and the mixture was heated to 80° C. in an inert atmosphere for 1.5 h to generate an isocyanate terminated PDMS pre-polymer (Scheme 2). The reaction mixture was cooled to 50° C. before a solution of BHMPA (1.6588 g, 9.86 mmole) and NEt₃ (1.37 mL, 9.86 mmole) in DMAc (20 mL) was added dropwise over 15 min. After 1 h, PEG diol (5.0286 g, 4.93 mmole) was added in one portion followed by HDI (1.6588 g, 9.86 mmole). After a further 1 h, the temperature was increased to 80° C. and the reaction was allowed to continue at this temperature for 16 h. The viscous reaction mixture was decanted into rectangular Teflon dishes (14.5×7.5×1 cm) and the solvent was evaporated in vacuo (50° C., 50 mbar, 16 h) to give polymer sheets suitable for further characterisation and processing. The polymer was isolated as the carboxylic acid analogue shown in FIG. 3.

Characterisation:

¹H NMR: (400 MHz, CDCl₃) δ 0.04-0.08 (br, 53H, f), 0.48 (m, 4H, e), 1.15-1.37 (br. m, 16H+6H, j/o), 1.45 (br. m, 16H, i), 1.58 (m, 4H, d), 3.13 (br. m, 16H, h), 3.39 (t, J=7.1 Hz, 4H, c), 3.61 (s, 92H, b/l), 4.17 (br, 4H+4H+8H, a/kin), 4.60-6.11 (br, 8H, g). GPC(THF): M_{w} 33,800, M_{w}/Mₙ 1.56.

### Example 9

Synthesis of Neutral Polyurethane Functionalised with N-Ethyl-Diethanolamine Suitable for Post-Synthetic Modification, PDMS(1)-PEG(1)-NEt(EtOH)₂(2)-HDI(4)

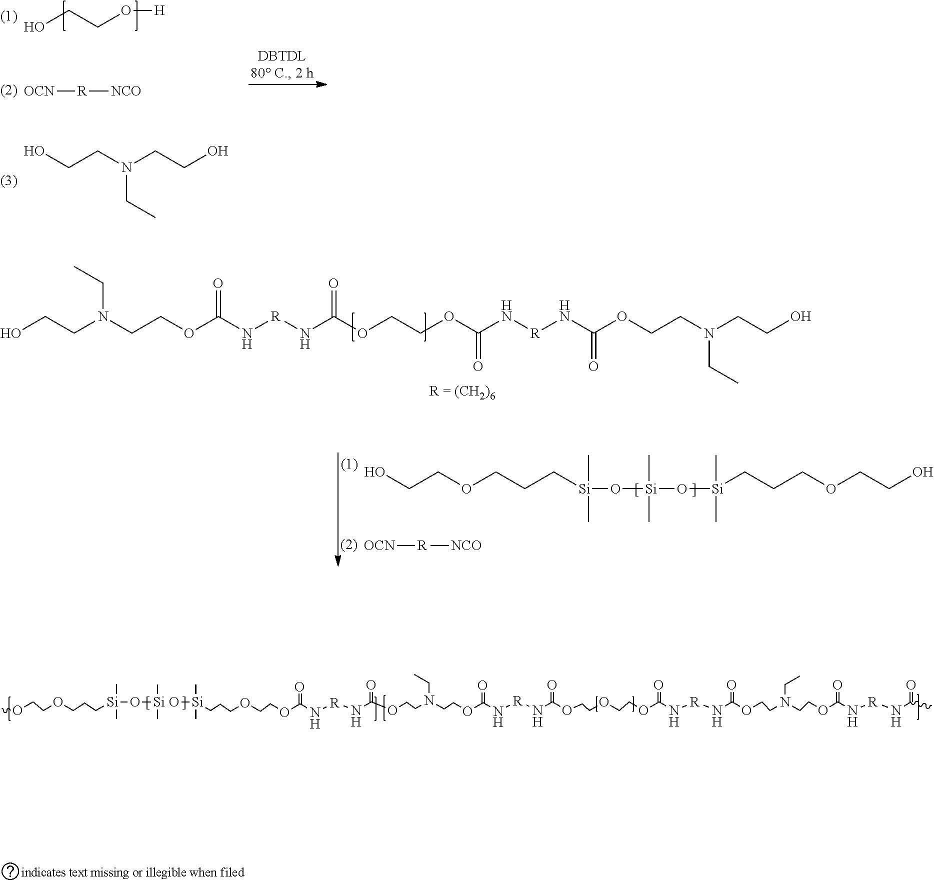

Scheme 3 Synthesis of Neutral Polyurethane Functionalised with N-Ethyl-Diethanolamine

The neutral polymer was synthesised using a modified two-step procedure, as given in Scheme 3. PEG (5.9860 g, 5.87 mmole) and (NEt[EtOH]₂, 1.5633 g, 11.8 mmole) were weighed by syringe into a 250 mL, 3-neck round bottom flask fitted with a magnetic stirrer, subaseal, N₂ inlet, and dropping funnel. The polyols were dissolved in anhydrous DMAc (10 mL) at 80° C. under N₂ flow, and the DBTDL catalyst was added (0.01 wt %). A solution of HDI in DMAc (1.9741 g, 11.8 mmole in 10 mL) was added dropwise over 0.5 h.

After 1.5 h, infrared analysis confirmed that the reaction mixture was free from non-reacted isocyanate which indicated that the expected di-NEt[EtOH]₂ terminated PEG pre-polymer had formed. PDMS (5.4478 g, 5.87 mmole) was then added and the mixture was diluted with DMAc to generate a clear, homogenous solution (20 mL). A second solution of HDI in DMAc (1.9741 g, 11.8 mmole in 10 mL) was added dropwise over 0.5 h, and the polymerisation was continued for a further 16 h at 80° C. The reaction mixture was decanted into rectangular Teflon dishes (14.5×7.5×1 cm) and the solvent was evaporated in vacuo (50° C., 50 mbar, 16 h). The structure and proposed ¹H NMR assignment of the neutral polymer are shown in FIG. 4.

Characterisation:

¹H NMR: (400 MHz, CDCl₃) δ 0.04-0.08 (br, 63H, f), 0.48 (m, 4H, e), 1.00 (t, J=7.1 Hz, 6H, q), 1.29 (br. m, 16H, j), 1.45 (br. m, 16H, i), 1.58 (m, 4H, d), 2.60 (q, J=7.1 Hz, 4H, p), 2.71 (t, J=5.7 Hz, 8H, o), 3.13 (br. m, 16H, h), 3.39 (t, J=7.1 Hz, 4H, c), 3.61 (s, 92H, b/l), 4.08 (t, J=5.7 Hz, 8H, n), 4.17 (br. t, 8H, a/k), 4.89 and 5.00 (2×br. s, 2H, g) GPC(DMAc+LiBr): Mₙ 65,700, M_{w}/Mₙ 1.92.

### Example 10

### Synthesis of Cationic Polyurethane, PDMS(1)-PEG(1)-Me⁺NEt(EtOH)(2)-HDI(4)

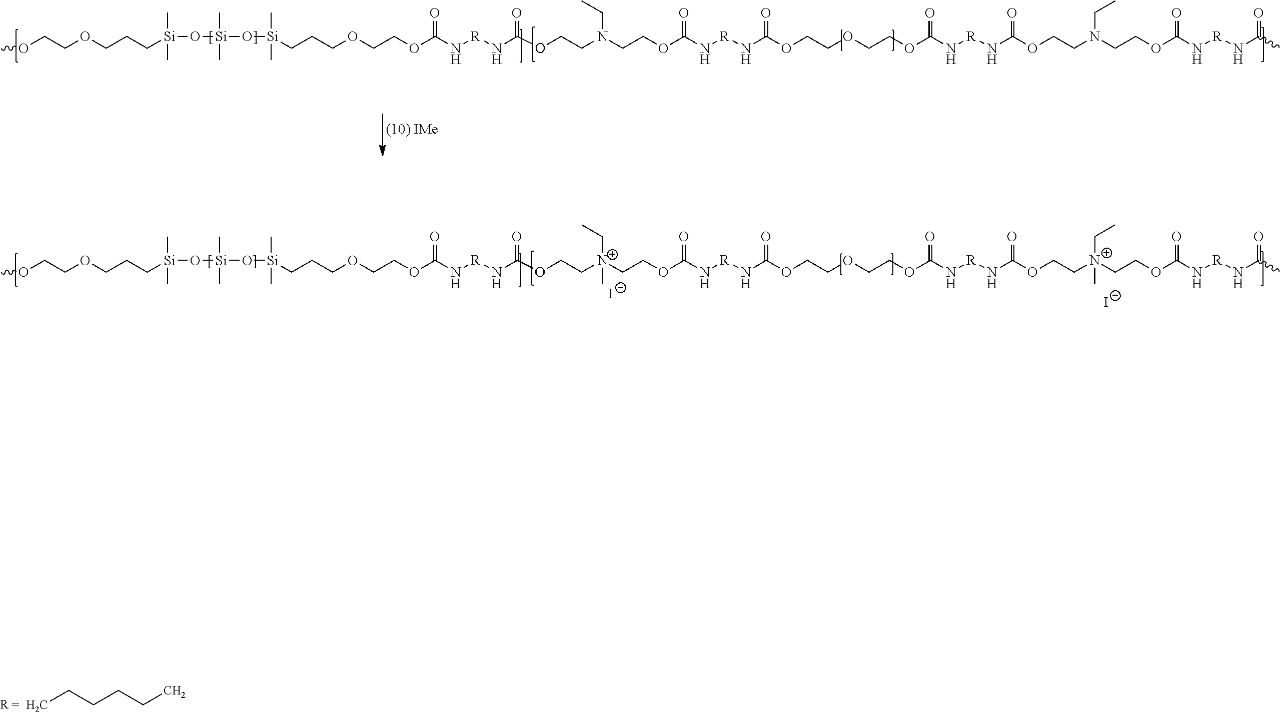

Scheme 4 Synthesis of Cationic Polyurethane

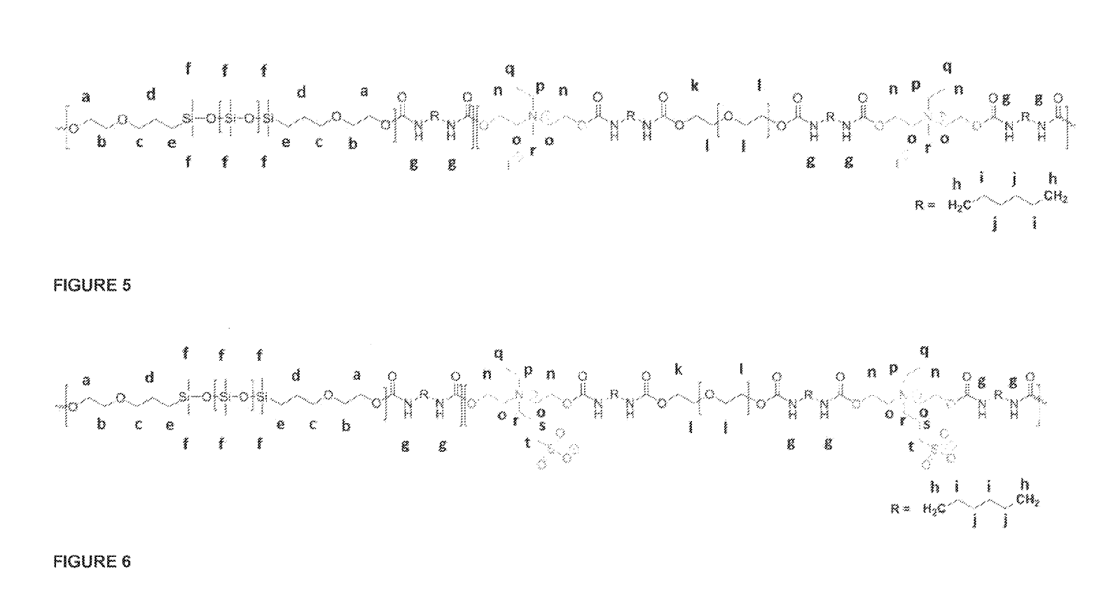

The cationic polymer was prepared by quarternisation of the tertiary amine nitrogen atoms of the polymer described in Example 9 with iodomethane (IMe), as shown in Scheme 4. Neutral PDMS(1)-PEG(1)-NEt(EtOH)₂(2)-HDI(4) (3.1095 g, containing 2.41 mmole tertiary N sites) was dissolved in LC-grade THF (20 mL) under N₂ at 25° C. IMe (4.1174 g, 24.1 mmole) was added via syringe, and the mixture was stirred overnight (16 h). It was noted that the reaction solution became orange within 10 min, and the viscosity increased significantly after 5 h reaction. The reaction mixture was diluted with 20 mL THF and the solution was decanted into stirring diethyl ether (200 mL) to precipitate the polymer. The precipitate was isolated by filtration and dried in a vacuum desiccator overnight (25° C., 50 mbar). The structure and proposed ¹H NMR assignment for the cationic polyurethane are shown in FIG. 5.

Characterisation:

Recovery: 68%. ¹H NMR: (400 MHz, CDCl₃) δ 0.04-0.08 (br, 55H, f), 0.48 (m, 4H, e), 1.29 (br. s, 16H, j), 1.45 (br. m, 16H+6H, i/q), 1.58 (m, 4H, d), 3.12 (br. m, 16H, h), 3.39 (m, 4H+8H, c/o), 3.61 (s, 92H, b/l), 3.75 (m, 4H, p), 3.90 (br. s, 6H, r), 4.17 (br. t, 8H, a/k), 4.55 (br. s, 8H, n), 4.78 and 4.89 (2×br. s, 2H, g), 6.50 (br. s, 4H, g next to cation). GPC (DMAc+LiBr): Mₙ 48,500, M_{w}/Mₙ 1.46.

### Example 11

Synthesis of the Zwitterionic Polyurethane, PDMS(1)-PEG(1)-propSO₃⁻⁺NEt(EtOH)₂(2)-HDI(4)

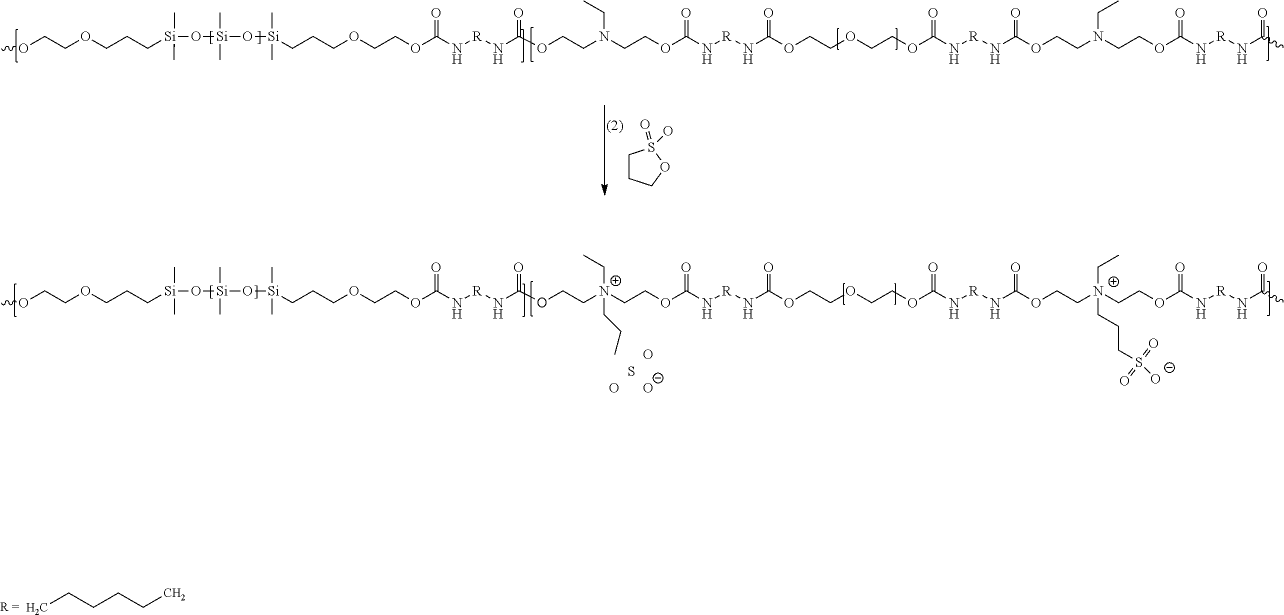

Scheme 5 Synthesis of Zwitterionic Polyurethane

The zwitterionic polymer was prepared by quarternisation of the tertiary amine nitrogen atoms of the polymer described in Example 9 using 1,3-propanesultone, as shown in Scheme 5. Neutral PDMS(1)-PEG(1)-NEt(EtOH)₂(2)-HDI(4) (2.3051 g, containing 1.78 mmole tertiary N sites) was dissolved in anhydrous THF (20 mL) under N₂ at 40° C. PS (0.6103 g, 3.57 mmole) was added via syringe, and the mixture was stirred overnight (20 h). The reaction mixture was decanted into stirring diethyl ether (150 mL) to precipitate the sulfobetaine functional polymer, which was subsequently isolated by filtration and dried in a vacuum desiccator overnight (25° C., 50 mbar). The structure and proposed ¹H NMR assignment for the zwitterionic polymer are shown in FIG. 6.

Characterisation:

Recovery: 60%. ¹H NMR: (400 MHz, CDCl₃) δ 0.04-0.08 (br, 51H, f), 0.48 (m, 4H, e), 1.00 (t, J=7.1 Hz, 6H, q), 1.29 (br. m, 16H, j), 1.45 (br. m, 16H, i), 1.58 (m, 4H, d), 2.20 (br. s, 2H [50%], s), 2.62 (br. m, 4H, p), 2.74 (br. s, 8H, o), 3.11 (br. m, 16H, h), 3.21 (t, J=8.0 Hz, 2H [50%], r), 3.39 (t, J=7.1 Hz, 4H, c), 3.61 (s, 92H, b/l), 4.08 (t, J=5.7 Hz, 4H [50%]), neutral n), 4.17 (br. t, 4H+4H+4H [50%], a/k/n), 4.94 (br., 8H, g). GPC (DMAc+LiBr): Mₙ 39,200, M_{w}/Mₙ 1.69.

### Preparation of Pre-Formed Films

### Example 12

### Preparation of Compression Moulded Films

Pre-formed film samples (of approximately 300±50 μm thickness) were obtained by melt-pressing the polymer at 60° C. under 7 tonne pressure for 1 min, followed by cooling to 13° C. via the circulation of cold water through the platens. The final dimensions of the films were ca. 7 cm×7 cm×300 μm.

### Characterisation of Surface Switching Phenomena

### Example 13

### Methods for Screening Water-Triggered Hydrophobic-Hydrophilic Surface Switching

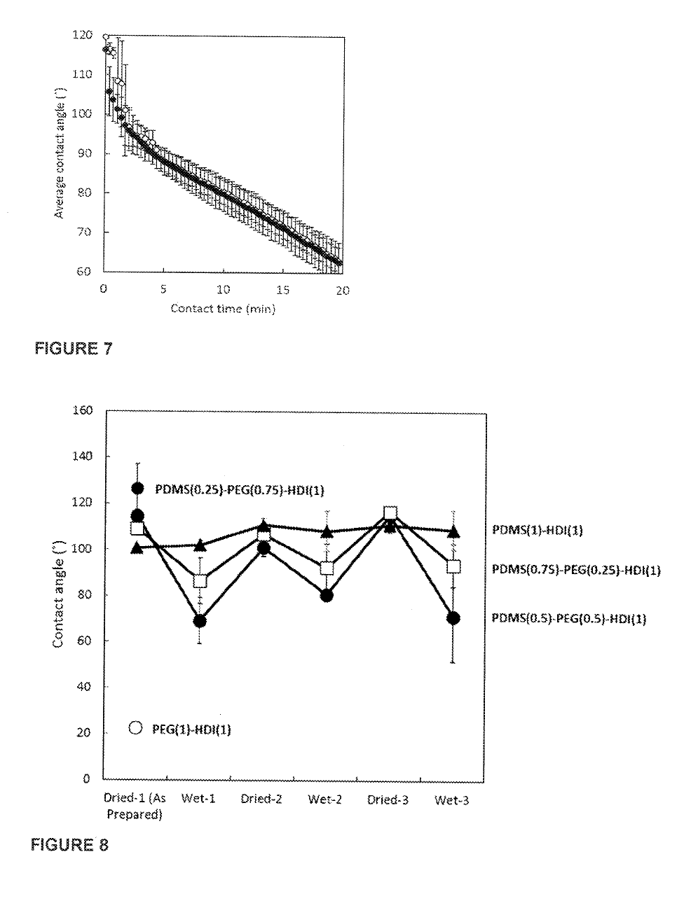

It was noted that the water contact angle measured on solvent cast film samples of non-ionic PDMS-PEG-HDI materials (Example 1-Example 5), reduced with increasing time of exposure to the water droplet (see FIG. 7). Referring to FIG. 7, the surfaces of both PDMS(0.75)-PEG(0.25)-HDI(1) and PDMS(0.50)-PEG(0.50)-HDI(1) clearly undergo a rapid increase in their wettability, as indicated by the water contact angle decreasing from ˜θ=120° to ˜θ=63° in 20 min (Δθ=57°). However, the most rapid decrease to water contact angle occurred during the first 2 min contact time, which corresponded to a change of approximately 8.9°·min⁻¹ for PDMS(0.50)-PEG(0.50)-HDI(1) and 11.5°·min⁻¹ for PDMS(0.75)-PEG(0.25)-HDI(1). These rapid changes are attributed to restructuring of the surface groups from predominantly hydrophobic PDMS segments to a surface enriched with more hydrophilic PEG groups upon prolonged contact time with the water droplet.

In order to establish the reversibility of the hydrophobic-hydrophilic surface switching phenomena, the water contact angle of dry and hydrated melt-pressed polymer samples (prepared according to the method given in Example 12) were measured over three cycles of hydration (soaking in milliQ water for 1 h), and drying (samples dried in vacuo 4 h, 40° C., 50 mbar). Prior to measuring the water contact angle on the hydrated samples, the films were removed from the water bath, blotted dry with paper towel and analysed immediately. The results are shown in FIG. 8.

PEG(1)-HDI(1) was water soluble, so its water contact angle could only be measured on the dry, freshly prepared sample. PDMS(0.25)-PEG(0.75)-HDI(1) absorbed large amounts of water (ca. 250% compared to its dry weight), and its surface became damaged after the first hydration cycle which prevented further water contact angle measurements. Nevertheless, the initial water contact angle of this material, was the highest measured (θ=126.5°). The PDMS(1)-HDI(1), PDMS(0.75)-PEG(0.25)-HDI(1) and PDMS(0.5)-PEG(0.5)-HDI(1) remained in good condition after each hydration-drying cycle, thereby allowing a full set of water contact angle measurements to be made. As expected, predominantly hydrophobic PDMS(1)-HDI(1) only underwent minor changes to its water contact angle over the three measurement cycles, with an average water contact angle of θ=105.6°. The average water contact angle on dried PDMS(0.75)-PEG(0.25)-HDI(1) was θ=110.8°, but this angle reduced by 20.1° when the polymer was hydrated. PDMS(0.50)-PEG(0.50)-HDI(1) displayed more extreme differences in water contact angle between dry and hydrated states (ave Δ33.1°).

### Example 14

### Method for Estimation of Surface-Free Energy

Owen and Wendt define the surface free energy of a polymer (γₛ) as the sum of its polar (γₛ^{p}) and dispersive (γₛ^{d}) surface energy components (as per Equation 1). To estimate the polar and dispersive surface energy components of the PDMS-PEG-HDI materials, the contact angles (θ) of two well-defined probe liquids (water and diiodomethane) were measured in triplicate on the surfaces of melt-pressed polymer films. Water is a polar molecule that possesses a total surface energy of γₗ₁=72.8 mJ·m⁻² (comprising dispersive and polar components of γₗ^{d}=21.8 mJ·m⁻² and γₗ^{p}=51 mJ·m⁻², respectively). On the other hand, diiodomethane is largely dispersive, with a total surface energy of γₗ=51 mJ·m⁻² (the sum of its dispersive and polar components of γₗ^{d}=48.6 mJ·m⁻² and γₗ^{p}=2.4 mJ·m⁻², respectively).

γₛ=γₛ^{p}+γₛ^{d}

Equation 1.

Surface free energy of a polymer is the sum of its polar and dispersive surface components.

The measured contact angles and known energy components of the probe liquids were substituted in the equations given in Equation 2 to generate x,y coordinates which were subsequently used to construct an Owen-Wendt plot for each material. According to this method, the relationship between the values calculated using the two probe liquids is linear (y=mx+c), with the square of the gradient (m) and square of the y-intercept (c) equal to the polar surface energy (γₛ^{p}) and dispersive surface energy (γₛ^{d}) contributions of the polymer, respectively. These parameters permit estimation of the surface free energy of the polymer (γₛ) according to Equation 1.

$$x = \sqrt{{γ}_{l}^{p} / {γ}_{l}^{d}}$$

$$y = \frac{1 + cos θ}{2} \cdot \frac{{γ}_{l}}{\sqrt{{γ}_{l}^{d}}}$$

Equation 2.

Equations to calculate x, y values for the Owen-Wendt plot.

The surface free energies of the melt-pressed polymer films, estimated using the Owen-Wendt method, are summarised in Table 1 The contact angles were measured within the first 4 seconds contact of the probe liquid with the polymer surface. Where possible, the initial contact angles of H₂O and CH₂I₂ were measured on dry (denoted with the suffix ‘-D’) and hydrated (denoted with the suffix ‘-H’) melt-pressed samples. Hydrated polymer samples were prepared by immersion in water for 5 min.

PEG(1)-HDI(1) dissolved in water while the surface of PDMS(0.25)-PEG(0.75)-HDI(1) fractured upon immersion which prevented the contact angle measurements on the hydrated samples.

After hydration, the surface-free energies of the amphiphilic PDMS-PEG-HDI materials approximately doubled (see Table 1). These increases in the total surface free energy values were accompanied by marked increases in the polar surface energy component, which are characteristic of surface enrichment by hydrophilic PEG moieties.

Cationic PDMS(1)-PEG(1)-Me⁺NEt(EtOH)₂(2)-HDI(4) underwent the largest change in its surface free energy upon hydration (Δ27 mg·m⁻²), which implies that the incorporation of a small number of cationic species greatly enhances the water-triggered surface switching behaviour of amphiphilic polymers derived from PDMS and PEG.

TABLE 1
Surface-free energies of selected polymers. Where possible,
the initial contact angles of H₂O and CH₂I₂ were measured on
dry (denoted with the suffix ‘-D’) and hydrated (denoted
with the suffix ‘-H’) melt-pressed samples. Hydrated polymer
samples were prepared by immersion in water for 5 min and were
blotted dry with paper towel and analysed immediately.

| | | | Surface |
|---|---|---|---|
| | | Disper- | free |
| | Polar | sive | energy |
| | (mJ · | (mJ · | (mJ · |
| Polymer | m⁻²) | m⁻²) | m⁻²) |
| PDMS(1)-HDI(1)-D | 0.2 | 9.7 | 9.9 |
| PDMS(1)-HDI(1)-H | 0.1 | 14.4 | 14.5 |
| PDMS(0.75)-PEG(0.25)-HDI(1)-D | 0.5 | 9.5 | 10.0 |
| PDMS(0.75)-PEG(0.25)-HDI(1)-H | 10.2 | 13.1 | 23.3 |
| PDMS(0.50)-PEG(0.50)-HDI(1)-D | 0.1 | 14.7 | 14.8 |
| PDMS(0.50)-PEG(0.50)-HDI(1)-H | 8.5 | 17.9 | 26.5 |
| PDMS(0.25)-PEG(0.75)-HDI(1)-D | 0.3 | 9.9 | 10.2 |
| PDMS(0.25)-PEG(0.75)-HDI(1)-H | — | — | — |
| PEG(1)-HDI(1)-D | 23.7 | 21.6 | 45.3 |
| PEG(1)-HDI(1)-H | — | — | — |
| PDMS(0.40)-PCL(0.1)-PEG(0.50)-HDI(1)-D | 0.0 | 17.7 | 17.7 |
| PDMS(0.40)-PCL(0.1)-PEG(0.50)-HDI(1)-H | 9.2 | 9.5 | 18.7 |
| PDMS₂₀₀₀(0.25)-PEG₁₀₀₀(0.75)-HDI(1)-D | 1.9 | 6.0 | 7.9 |
| PDMS₂₀₀₀(0.25)-PEG₁₀₀₀(0.75)-HDI(1)-H | 1.2 | 14.9 | 16.1 |
| PDMS(1)-PEG(1)-NEt(EtOH)₂(2)-HDI(4)-D | 0.5 | 11.6 | 12.2 |
| PDMS(1)-PEG(1)-NEt(EtOH)₂(2)-HDI(4)-H | 6.6 | 11.8 | 18.4 |
| PDMS(1)-PEG(1)-Me⁺NEt(EtOH)₂(2)- | 0.1 | 14.7 | 14.8 |
| HDI(4)-D | | | |
| PDMS(1)-PEG(1)-Me⁺NEt(EtOH)₂(2)- | 29.1 | 12.6 | 41.7 |
| HDI(4)-H | | | |

### Example 15

### Grazing-Incidence XPS Analysis

Sample Preparation and Analysis

An aliquot (50 μL) of a CH₂Cl₂ solution of the polymer (20 mg·mL⁻¹) was deposited onto a silicon wafer and allowed to evaporate in ambient conditions for 24 h prior to analysis. X-ray photoelectron spectroscopy (XPS) analysis was performed using an AXIS Nova spectrometer (Kratos Analytical Inc., Manchester, UK) with a monochromated Al K_{α} source at a power of 180 W (15 kV×12 mA) and a hemispherical analyser operating in the fixed analyser transmission mode. The total pressure in the main vacuum chamber during analysis was typically between 10⁻⁹ and 10⁻⁸ mbar. Survey spectra were acquired at a pass energy of 160 eV. To obtain more detailed information about chemical structure, oxidation states etc., high resolution spectra were recorded from individual peaks at 40 eV pass energy (yielding a typical peak width for polymers of 1.0 eV).

Each specimen was analysed at an emission angle of 0° and 60° as measured from the surface normal. Assuming typical values for the electron attenuation length of relevant photoelectrons the XPS analysis depth (from which 95% of the detected signal originates) ranges between 5 and 10 nm for a flat surface at an emission angle of 0°.

### Quantification

Data processing was performed using CasaXPS processing software version 2.3.15 (Casa Software Ltd., Teignmouth, UK). All elements present were identified from survey spectra. The atomic concentrations of the detected elements were calculated using integral peak intensities and the sensitivity factors supplied by the manufacturer. Binding energies were referenced to the main C 1s peak (aliphatic carbon) at 285 eV. The accuracy associated with quantitative XPS is ca. 10%-15%. Precision (i.e. reproducibility) depends on the signal/noise ratio but is usually much better than 5%. The latter is relevant when comparing similar samples.

### XPS

From the initial surface free energy measurements performed on the dry PDMS-PEG-HDI materials, it appeared as though PDMS components were preferentially enriched at the surface of the dry films (i.e. the polymer-air interface). Grazing-incidence XPS was used to examine the surface elemental composition and to also quantify possible differences in the PDMS/PEG ratio in the top ˜0-2 nm vs the top ˜0-10 nm of the surfaces of dry, vacuum-treated samples of the amphiphilic PDMS-PEG-HDI materials.

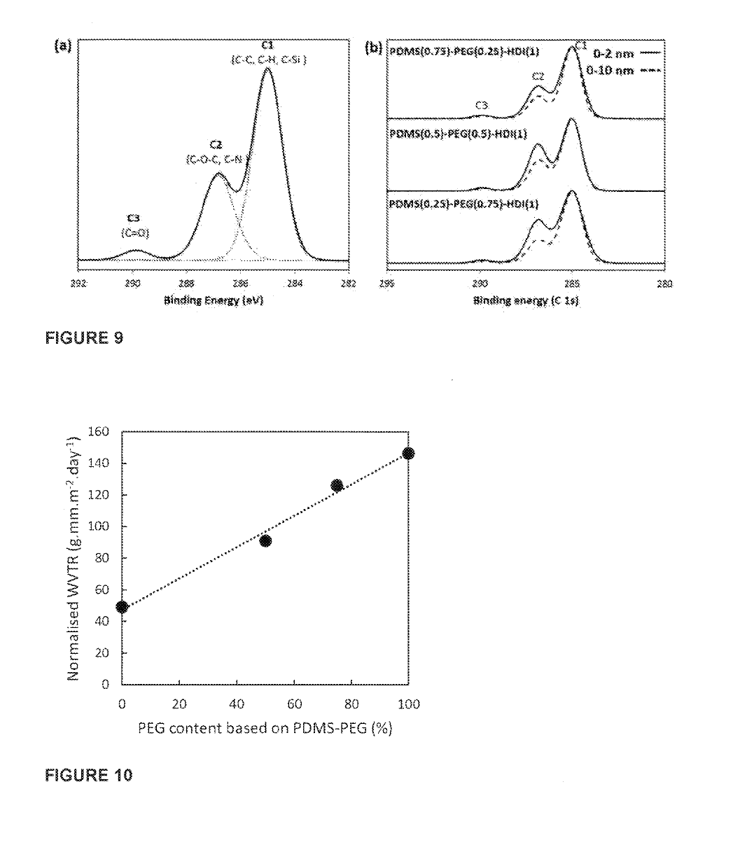

XPS results of synthesised polymers (Examples 2-4) are given in Tables 2 and 3 and FIG. 9. Tables 2 and 3 and FIG. 9 show that PDMS is enriched in the uppermost surface layer (˜0-2 nm). This finding is consistent with the low surface free energy values measured on the dry, melt-pressed polymer films that are presented in Table 1.

TABLE 2
Ratio of Si 2p/O 1s percentages measured from XPS survey scans.

| | PDMS(0.25)- | | PDMS(0.5)- | | PDMS(0.75)- | |
|---|---|---|---|---|---|---|
| | PEG(0.75)-HDI(1) | | PEG(0.5)-HDI(1) | | PEG(0.25)-HDI(1) | |
| Atomic | ~0-10 | ~0-2 | ~0-10 | ~0-2 | ~0-10 | ~0-2 |
| % | nm | nm | nm | nm | nm | nm |
| O 1s | 24.80 | 23.67 | 24.75 | 24.21 | 23.60 | 23.22 |
| N 1s | 1.79 | 1.23 | 2.10 | 1.53 | 2.22 | 1.61 |
| C 1s | 60.69 | 58.34 | 60.63 | 59.31 | 60.06 | 58.55 |
| Si 2p | 12.74 | 16.73 | 12.53 | 14.95 | 14.15 | 16.58 |
| Si 2p/ | 0.21 | 0.29 | 0.21 | 0.25 | 0.24 | 0.28 |
| C 1s | | | | | | |

TABLE 3
Peak areas obtained by fitting XPS C 1s
spectra, and the calculated of C1/C2 depth ratios.

| | PDMS(0.25)- | | PDMS(0.5)- | | PDMS(0.75)- | |
|---|---|---|---|---|---|---|
| | PEG(0.75)- | | PEG(0.5)- | | PEG(0.25)- | |
| | HDI(1) | | HDI(1) | | HDI(1) | |
| Peak area, % | ~0- | ~0- | ~0- | ~0- | ~0- | ~0- |
| (Assignment) | 10 nm | 2 nm | 10 nm | 2 nm | 10 nm | 2 nm |
| C1 | 60.0 | 73.7 | 58.7 | 67.6 | 65.6 | 72.3 |
| (C—C, | | | | | | |
| C—H, | | | | | | |
| C—Si) | | | | | | |
| C2 | 37.4 | 24.4 | 37.6 | 29.4 | 31.2 | 25.1 |
| (C—O—C, | | | | | | |
| C—N) | | | | | | |
| C3 | 2.6 | 1.9 | 3.7 | 3.0 | 3.2 | 2.6 |
| (C═O) | | | | | | |
| $\frac{C 1 / C {2}_{0 - 2 nm}}{C 1 / C {2}_{0 - 10 nm}}$ | 1.88 | | 1.47 | | 1.37 | |

### Investigation of Barrier Performance

### Example 16

### Measurement of Water Vapour Transmission (ASTM-E96)

### Sample Preparation

Pre-formed film samples (prepared according to the method given in Example 12). All samples were aged at room temperature for 1 week prior to the water vapour transmission experiments.

### Measurement Conditions

Water vapour transmission measurements were performed according to ASTM-E96 using the water method (apparatus is represented schematically in FIG. 10. Briefly, this entailed sealing the polymer specimen over a dish containing distilled water. The entire apparatus was weighed and then placed inside a humidity controlled chamber that was maintained at an atmosphere of 10% RH for a period of 1 week. The apparatus was weighed twice daily (once in the morning and once in the evening) to determine the rate of water vapour movement through the specimen.

FIG. 10 clearly shows that a linear relationship exists between PEG content and WVTR (normalized to the film thickness). As expected, PEG(1)-HDI(1) which contains the highest proportion of hydrophilic components, undergoes the fastest rate of transmission (140 g·mm·m⁻²·day⁻¹). Conversely, hydrophobic PDMS(1)-HDI(1) undergoes slowest transmission of water vapour (49.1 g·mm·m⁻²·day⁻¹). The WVTR of the amphiphilic materials fall linearly within these two extremes, but PDMS(0.75)-PEG(0.25)-HDI(1) could not be analysed using this method.

### Example 17

### Preparation of Aqueous Dispersions of the Polymers

PDMS(0.50)-PEG(0.50)-HDI(1) (from Example 3, 5.9 g) was dissolved in acetone (18.4 g), and added dropwise to an aqueous 1% SDS solution (63.9 g) with continuous stirring to give a gelatinous solid. The gel was diluted with H₂O (20.7 g) to enable stirring, and acetone was evaporated under a stream of N₂ gas for 16 h. A further 92.2 g of water was added in two portions and the mixture was stirred for 2 h to give a slightly viscous suspension of the polymer. The final ‘sprayable’ suspension was obtained by further dilution with H₂O (43.3 g) to achieve a final polymer content of 2.6 wt. %.

The same, general method was used to prepare polymer suspensions of the other materials in the non-ionic PDMS-PEG-HDI series. However, a suspension was unable to be obtained for PDMS(1)-HDI(1) as it precipitated under these conditions.

The viscosities of the resulting suspensions were measured using a Brookfield Programmable DV-II+ Viscometer, results given in Table 4.

TABLE 4
Viscosity of aqueous dispersions of polymers

| | | | | Ave. |
|---|---|---|---|---|
| | | | | viscosity |
| Polymer | Example | Spindle | RPM | (mPa · s) |
| PEG(1)-HDI(1) | Example 1 | 3 | 100 | 0.56 |
| PDMS(0.25)-PEG(0.75)- | Example 2 | 3 | 100 | 5.81 |
| HDI(1) | | | | |
| PDMS(0.5)-PEG(0.5)- | Example 3 | 2 | 5, 10, 20, | 4.67 |
| HDI(1) | | | 50, 100 | |
| PDMS(0.75)-PEG(0.25)- | Example 4 | 3 | 100 | 0.94 |
| HDI(1) | | | | |
| PDMS(1)-HDI(1) | Example 5 | — | — | — |

### Example 18

Assessment of Polymer Performance as a Barrier to Minimise Water Evaporation from Soil

[Initial laboratory screening experiments (20° C., 24-68% RH).

The performance of the polymers as water-borne barriers to minimise water evaporation from different soil types was screened using laboratory conditions (20° C., 30-45% RH). In the laboratory experiments, the bottom of a plastic weighing tray was pierced multiple times with a syringe needle. The pierced tray was filled with a known mass of soil (ca. 35 g) and a known mass of the polymer suspension (from Example 1. ˜4.5 g) was applied to the surface of the soil at an application rate of ˜35 g polymer·m⁻². The tray was placed in a fumehood and left to dry overnight. The next day, the tray was placed in a dish containing distilled water and was left to saturate the soil (ca. 1 min). The pierced tray containing the water saturated soil was placed inside another, non-pierced weighing tray to prevent moisture loss through the bottom of the sample. The samples were then weighed periodically over the day to measure the mass of water lost through evaporation. Three replicates of each sample as well as three controls (with no polymer applied) were run simultaneously in every experiment.

The mass loss data (g) were plotted against evaporation time (h), and the gradient of the linear portion of the mass loss curve was taken as the rate of evaporative moisture loss (g·h⁻¹). The measured rates of evaporative moisture loss and the corresponding reduction in the rate of evaporation due to polymer treatment (relative to the non-treated control samples) are given in Table 5.

TABLE 5
Rates of evaporative moisture loss determined for PDMS-PEG-HDI
materials (Examples 1-5) in laboratory screening experiments.
Polymer loading on the soil ranged between 35.1-42.4 g · m⁻².

| | | Rate of | Rate |
|---|---|---|---|
| | | evaporative | reduction |
| | | moisture loss | (relative to |
| Polymer | Soli | (g · h⁻¹) | control) |
| PEG(1)-HDI(1) | Sand^{I} | 0.61 | 18% |
| PDMS(0.25)-PEG(0.75)-HDI(1) | Sand^{I} | 0.50 | 33% |
| PDMS(0.50)-PEG(0.50)-HDI(1) | Sand^{I} | 0.34 | 48% |
| PDMS(0.75)-PEG(0.25)-HDI(1) | Sand^{I} | 0.58 | 21% |
| PDMS(0.50)-PEG(0.50)-HDI(1 | Sand^{II} | 0.46 | 33% |
| PDMS(0.50)-PEG(0.50)-HDI(1)^{A} | Clay | 0.42 | 42% |

Sand^{I} supplied by Sigma Aldrich; sand^{II} supplied by Ajax.
Humidity and temperature controlled experiments (30° C., 40% RH and/or 20° C., 54% RH)

The performance of polymers as a barrier to minimise water evaporation from sand (Sigma Aldrich) was examined under strictly controlled conditions of humidity and temperature (30° C., 40% RH or 20° C., 54% RH). In these experiments, a PVC pot was filled with a known mass of soil (ca. 250 g) and the polymer suspension (from Example 1, ˜4.5 g) was applied to the surface of the soil at an application rate of ˜40-50 g polymer·m⁻². The pot was placed in a fumehood and left to dry overnight. The next day, the pot was placed in a dish containing distilled water and was left until saturation of the soil was achieved (ca. 15-20 min, corresponding to a water uptake of 60-70 g). The pot was then placed on a balance in a humidity controlled room (maintained at 30° C., 40% RH or 20° C., 54% RH) and the mass was recorded every 15 min for several days in order to determine the rate of evaporative water loss from the soil. Three replicates of each sample as well as three controls (with no polymer applied) were run simultaneously in every experiment.

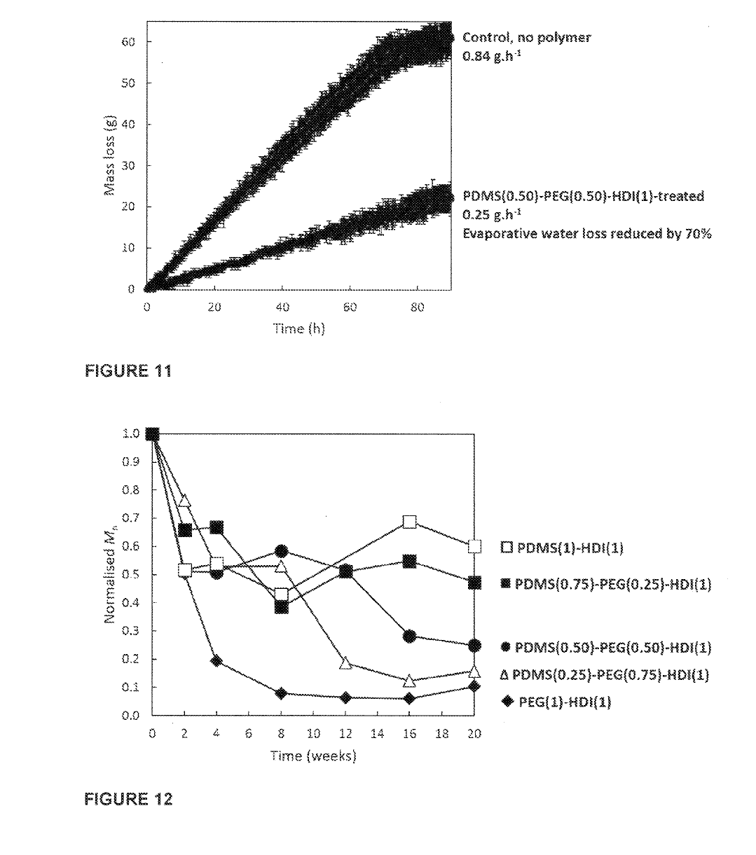

The mass loss data (g) were plotted against evaporation time (h), and the gradient of the linear portion of the mass loss curve was taken as the rate of evaporative moisture loss (g·h⁻¹), as shown in FIG. 11. The measured rates of evaporative moisture loss and the corresponding reduction in the rate of evaporation due to polymer treatment (relative to the non-treated control samples) are given in Table 6.

TABLE 6
Rates of evaporative moisture loss through non-ionic PDMS(0.5)-
PEG(0.5)-HDI(1) (Example 3) and cationic PDMS(1)-PEG(1)-
Me⁺NEt(EtOH)₂(2)-HDI(4) (Example 10) on sand in controlled
conditions of temperature and humidity. Polymer loading on
the sand ranged between 48-49 g · m⁻²

| | | | Rate |
|---|---|---|---|
| | | Rate of | reduction |
| | Condi- | evaporation | (relative to |
| Polymer | tions | (g · h⁻¹) | control) |
| PDMS(0.5)-PEG(0.5)-HDI(1) | 30° C., | 0.25 | 70% |
| | 40% RH | | |
| PDMS(1)-PEG(1)- | 30° C., | 0.21 | 74% |
| Me⁺NEt(EtOH)₂(2)-HDI(4) | 40% RH | | |
| PDMS(0.5)-PEG(0.5)-HDI(1) | 20° C., | 0.081 | 75% |
| | 54% RH | | |
| PDMS(1)-PEG(1)- | 20° C., | 0.032 | 90% |
| Me⁺NEt(EtOH)₂(2)-HDI(4) | 54% RH | | |

### Example 19

### Assessment of Water Uptake by Soil Through Polymer Film During Simulated Overhead Irrigation

Two methods were used to assess the permeability of the polymers on soil upon ‘simulated’ overhead irrigation.

Water Droplet Penetration Test

The permeability of the material to water upon overhead irrigation was tested by depositing a droplet of water on the soil surface loaded with the polymer, and measuring the time taken for the droplet to penetrate into the soil bed (results given in Table 7). Referring to Table 7, it was noted that initially the water droplet beaded on the surface (indicating a hydrophobic surface). After a period of time, the water passed into the sand bed (due to the surface becoming more hydrophilic, which allows the passage of water through the polymer film). Subsequent water droplets deposited on the wet (hydrophilic surface) passed straight through into the sand bed. Drying of the so-formed wet area resulted in regeneration of the initially hydrophobic surface.

TABLE 7
Time for water droplet to penetrate through PDMS(0.5)-
PEG(0.5)-HDI(1) (Example 3) film and into the sand bed.

| | | Average time taken for |
|---|---|---|
| | Polymer loading | water droplet to |
| Soil type | (g · m⁻²) | penetrate soil bed (s) |
| Sand, Sigma Aldrich | — | Immediate |
| Sand, Ajax | — | Immediate |
| Sand, Sigma Aldrich | 35.1 | 7.9 ± 1.3 |
| Sand, Sigma Aldrich | 56.6 | 44.8 ± 21.7 |
| Sand, Ajax | 35.3 | 5.9 ± 1.8 |
| Sand, Sigma Aldrich | 42.4 | 12.6 ± 1.9 |
| Sand, Sigma Aldrich (wet) | 42.4 | Immediate |
| Sand, Sigma Aldrich (redried) | 42.4 | 14.3 ± 1.5 |

### Re-Assessment of Evaporative Rate

Selected samples generated from the experiments outlined in Example 18 were re-wet by overhead watering with a jet of deionised water applied from a syringe with no needle fitted. The rate of evaporative moisture loss from the samples wet by overhead watering was determined from the weight lost over a 46 h period at 30° C., 40% RH (see Cycle 2 entries in Table 8). Overhead watering and assessment of the evaporative mass loss was repeated to give a third rate measurement (see Cycle 3 entries in Table 8).

Table 8 summarises the rates of evaporative mass loss was measured after overhead watering (Cycle 2 and Cycle 3) and compares these rates with the rate of evaporative water loss measured for the sample when wet from underneath the polymer film (Cycle 1, as outlined in the experiments in Example 18).

TABLE 8
Rates of evaporative moisture loss from sand (control, non-treated),
PDMS(0.5)-PEG(0.5)-HDI(1)-treated sand (48.2 g polymer · m⁻²)
and PDMS(0.45)-PEG(0.45)-N⁺(0.1)-HDI(1)-treated sand (48.9 g
polymer · m⁻²) in controlled conditions of temperature and
humidity (30° C., 40% RH) over several cycles of wetting.

| | Polymer | Cycle | Cycle | Cycle |
|---|---|---|---|---|
| | loading | 1^{I} | 2^{II} | 3^{II} |
| Polymer | (g · m⁻²) | (g · h⁻¹) | (g · h⁻¹) | (g · h⁻¹) |
| Control (no treatment) | — | 0.84 | 0.77 | 0.81 |
| PDMS(0.5)-PEG(0.5)-HDI(1) | 48.2 | 0.25 | 0.38 | 0.47 |
| PDMS(0.45)-PEG(0.45)- | 48.9 | 0.22 | 0.28 | 0.29 |
| N⁺(0.1)-HDI(1) | | | | |

^{I}Sand was saturated by immersion of pot in a pool of water (60-70 g water uptake);
^{II}Sand was saturated by overhead watering, meaning that water passed through the upper polymer-loaded sand surface and into the sand bed below (ca. 60 g water uptake).

### Example 20

### Hydrolytic Degradation

Eight pieces of each material (ca. 0.1 g) were accurately weighed and immersed in 25 mL H₂O in separate sealable glass vials. The sealed vials containing the sample were placed in an oven and left at 50° C. for 0, 2, 4, 8, 16, 20 and 28 weeks, respectively. At the end of the given incubation period, the entire sample was freeze-dried and a portion of the recovered solid was subjected to analysis by GPC to determine the average molecular weight (Mₙ, g·mole⁻¹) and polydispersity (M_{w}/Mₙ).

FIG. 12 follows the changes to the average polymer Mₙ over 20 weeks of hydrolysis at 50° C. for the non-ionic PDMS-PEG-HDI materials described in Examples 1-5. For clarity, Mₙ is normalised to the Mₙ of the starting polymer.

### Example 21

Hydrophobic-hydrophilic switchable polymers undergo surface rearrangements in response to the polarity of their surrounding environments to affect changes in their surface properties. Hydrophobic-hydrophilic switchable materials are amphiphilic in nature, comprising both hydrophobic and hydrophilic components that migrate and enrich at the surface when the material is in different environments. Typically, low surface energy hydrophobic moieties enrich at the polymer-air interface, while higher surface energy hydrophilic moieties enrich at the polymer surface when it is in contact with a polar liquid, such as water. In this way, the polymer can minimise its interfacial tension in both air and water in order to satisfy the interfacial energy requirements.

Measuring the changes in water contact angle over time at the surfaces of polymer samples is a convenient method to study these dynamic surface restructuring phenomena. In the following example we use this data to demonstrate the impact of various polymer structural features on the dynamics of hydrophobic-hydrophilic surface switching of PBD-derived poly(urethane) systems.

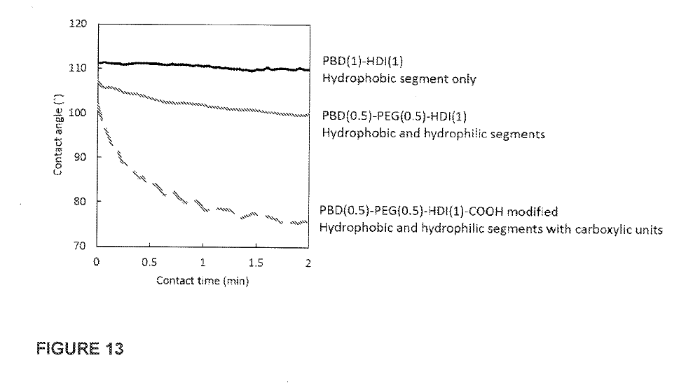

Solvent cast films of PBD(1)-HDI(1), PBD(0.5)-PEG(0.5)-HDI(1) and COOH-modified PBD(0.5)-PEG(0.5)-HDI(1) were prepared by depositing 50 μL of a THF solution of the polymer (30 mg mL⁻¹) onto a glass slide. The solvent was allowed to evaporate at ambient temperature for 1 h before drying at 40° C. in vacuo (250 mbar, 1 h). The change in water contact angle was then monitored for each material over a period of 2 min (results given in FIG. 13).

FIG. 13 Change to water contact angle over 2 min at the surface of solvent cast films of PBD(1)-HDI(1), PBD(0.5)-PEG(0.5)-HDI(1) and COOH-modified PBD(0.5)-PEG(0.5)-HDI(1).

Referring to FIG. 13, the surface of PBD(1)-HDI(1) which comprised only hydrophobic PBD segments, displayed a stable water contact angle of 110-111°. However, the introduction of hydrophilic PEG segments, as for amphiphilic PBD(0.5)-PEG(0.5)-HDI(1), generated a more dynamic surface. The water contact angle of this polymer was initially 106°, but material surface gradually became more hydrophilic with prolonged contact with the water droplet, to give a water contact angle of 99° after 2 min.

These data indicate that low surface energy hydrophobic PBD moieties enrich at the polymer-air interface leading to high initial water contact angles. After prolonged contact with the water droplet, the higher surface energy hydrophilic PEG components of amphiphilic PBD(0.5)-PEG(0.5)-HDI(1) begin enriching at the polymer-water interface causing a decrease in the water contact angle. In contrast, the hydrophobic surface of PBD(1)-HDI(1) is retained over 2 min, because this polymer lacks hydrophilic segments; thereby eliminating any potential for hydrophilic surface enrichment at the polymer-water interface.

The random incorporation of pendent carboxylic acid groups along the hydrophobic segment, as for COOH-modified PBD(0.5)-PEG(0.5)-HDI(1), further enhances the surface restructuring dynamics. Initially, the surface of the COOH-modified polymer was hydrophobic, displaying a water contact angle of 102°. Within 2 min contact time with the water droplet, the polymer surface transitions to a hydrophilic one (water contact angle 76°). The addition of hydrophilic carboxylic acid groups to this polymer means that when it is in contact with water, the polymer surface enriches with both PEG and carboxylic acid groups which results in the development of a hydrophilic surface.

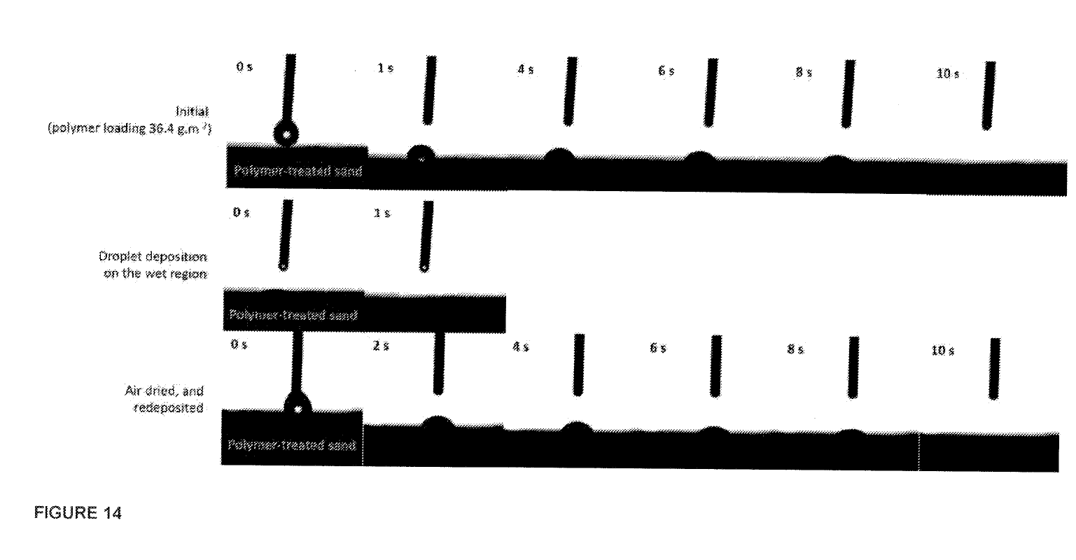

FIG. 14: Hydrophobic-hydrophilic transitioning of PDMS(0.5)-PEG(0.5)-HDI(1) treated soil which allows water to pass through the upper treated soil layer and into the soil beneath.

### Example 22

### Synthesis of Non-Ionic PBD(0.5)-PEG(0.5)-HDI(1)

The polymer was prepared using a similar method to that given in Example 1, except the following precursors and quantities were used: PBD (8.2264 g, 3.39 mmole), PEG (3.4618 g, 3.39 mmole) and HDI (1.1417 g, 6.79 mmole). PBD(0.5)-PEG(0.5)-HDI(1) contained approximately 12.4 mmole alkenes per gram.

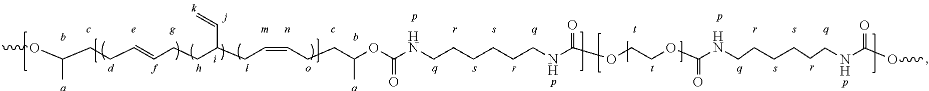

### Characterisation Data:

¹H NMR: (400 MHz, CDCl₃) δ 0.99-1.60 (br. m, 44.2H, a, c, h, r, s), 1.80-2.20 (br. m, 46.9H, d, g, l, o, i), 3.06-3.22 (m, 4H, q), 3.66 (s, 43.6H, t), 4.14-4.29 (m, 2H, b), 4.81-5.08 (br. m, 27.6H, k, p), 5.22-5.66 (br. m, 27.8H, e, f, j, m, n). GPC(THF): M_{w} 35,500, M_{w}/Mₙ 1.71.

### Example 23

Modification of PBD(0.5)-PEG(0.5)-HDI(1) with Pendent COOH Groups

PBD(0.5)-PEG(0.5)-HDI(1) (0.2368 g, containing 2.93 mmole alkene) and TiO₂ (0.2 alkene equivalents) were weighed into a 10 mL microwave vial covered with aluminium foil to exclude ambient light. THF (3 mL) was added and the vial was sealed. Once the polymer had dissolved, MPA was added via syringe (2.93 mmole, 0.26 mL). The lid of the vial was punctured with a fresh syringe needle which was left in place to act as an air inlet and vent. The aluminium foil was removed from the vial and the mixture was irradiated for 3 h with visible light from a 150 W clamp floodlight (Nelson) purchased from a local hardware store at a distance of 20 cm from the light source. The reaction mixture was filtered through a 0.45 μm syringe filter and the solvent was evaporated by rotary evaporator. A THF solution of the crude polymer was precipitated into H₂O and the polymer was isolated by filtration then lyophilised overnight. NMR was used to confirm successful derivatisation of the PBD alkene groups with thioethers. In D6-DMSO, new peaks associated with S—CH₂ and CH₂—COOH were observed at 2.45 and 2.63 ppm, respectively. Alkene conversion to thioester was approximately 65%.

### Example 24

### PCL(0.5)-PEG(0.5)-HDI(1)

The polymer was prepared using a similar method to that given in Example 1, except the following quantities and precursors were used: PCL (5.7252 g, 6.17 mmole), PEG (6.2908 g, 6.17 mmole) and HDI (2.0746 g, 12.3 mmole).

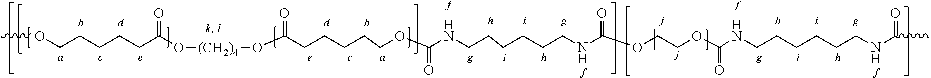

### Characterisation Data:

¹H NMR: (400 MHz, CDCl₃) δ 1.26-1.56 (br. m, 32.2H, c, h, i), 1.56-1.73 (br. m, 31.4H, b, d), 2.01 (br. s, 4H, l), 2.26-2.39 (br. m, 15.7H, e), 3.06-3.20 (m, 8H, g), 3.64 (s, 92.4H, j), 3.80-3.91 (br. m, 4H, k), 3.97-4.12 (br. m, 15.5H, a), 4.16-4.26 (m, 4H, a and j near urethanes), 4.76 and 4.92 (br. s, 2×2H, f). GPC(DMAc+LiBr): Mₙ 68,900, M_{w}/Mₙ 1.71. DSC: T_{g} not observed; T_{c}−20.3° C., (26.9 J·g⁻¹); Tₘ 23.5° C., −28.5 J·g⁻¹.

### Example 25

Alternative synthetic approaches to generate poly(urethane)s in the absence of isocyanates are described below:

Reaction of hydrophobic and hydrophilic macromolecular segments with either bis(chloroformate) or diamine termini and either a bis(chloroformate) or diamine terminated small molecule to generate a poly(urethane).

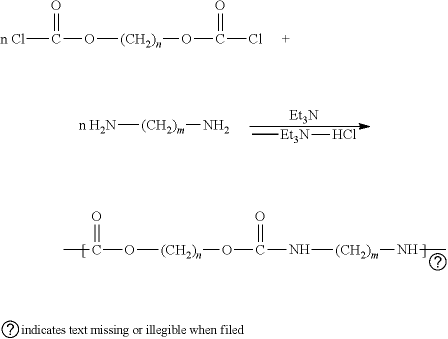

Reaction of hydrophobic and hydrophilic macromolecular segments with either dicyclic carbonate or aliphatic diamine termini and either a dicyclic carbonate or aliphatic diamine small molecule to generate a poly(hydroxy-urethane).

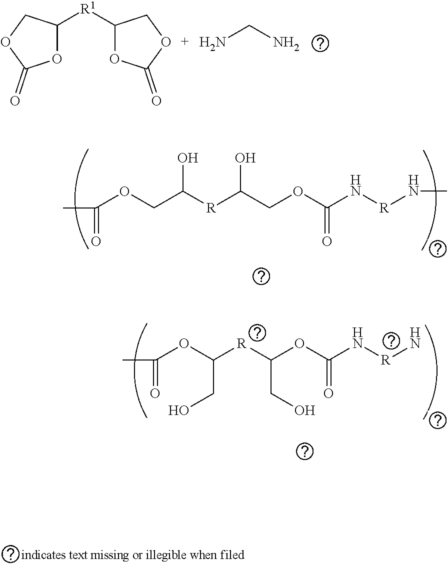

### Terms

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

Herein, the term “polyurethane” relates to a polymer chain that comprises urethane (carbamate, —NH—COO—) links which connect monomer or “macro-monomer” units. Polyurethanes can be produced via the reaction of molecules containing a minimum of two isocyanate functional groups with other molecules which contain at least two alcohol (hydroxyl) groups.

Herein, the term “polyurethane-urea” relates to a polymer chain that comprises both urethane and urea linking groups.

The term “polymer backbone” refers to the main chain of a linear or branched polymer.

Herein, the term “polyol” denotes a compound, which has “active hydrogen containing” groups that can be reacted and includes materials having an average of about two or more hydroxyl groups per molecule.

Polyols include but are not limited to diols, triols, and tetraols and macrodiols.

Herein, the term “active hydrogen containing” refers to compounds having hydrogen atoms which can react with isocyanate groups. For example, such hydrogen atoms include hydrogen atoms attached to oxygen, nitrogen or sulphur and include compounds which have at least two groups selected from the group consisting of —OH, —SH and —NH—.

Herein, the term “macrodiol” refers to a polymeric material comprising two hydroxyl groups. For example, a copolymer segment of Formula 1 with two hydroxyl groups.

Herein, the term “mulch” is used to refer to a layer of membrane applied to the surface of an area of soil used in crop production.

Herein, the term “plants” refers to all physical parts of plants including seeds, seedlings, saplings, roots, tubes and material from which plants may be propagated.

Herein, the term “agriculture”, refers to the cultivation of animals, plants, fungi, and other life forms. In particular in the context of the present invention agriculture refers to cultivation of crops for food, fiber, biofuel, medicinal and other products used to sustain and enhance human life.

Herein, the term “soil materials” refers to soil and its solid components, including minerals and/or organic matter and a porous component that hold gases, water, solutes and organisms. Soil materials can vary from being soft and friable in some situations to a hard and structureless mass with concrete like properties in others. While soils are the foundation for natural and agricultural ecosystems, they also serve as the foundation for most construction and are used in a range of engineering and other applications, including concrete, road foundations, liners in irrigation canals and aquaculture ponds, and as capping materials for mine waste dumps and municipal waste dumps. In its broadest context, soil materials used in agriculture include construction materials such as concrete which may be used in agriculture applications such as structures for retaining soil, irrigation channels or conduits and the like. Typical soil materials used in agriculture include raised beds, pastures, ridges, furrows and irrigation channels. The invention is useful on a wide range of soil types and soil classifications such as referred to in the World Reference Base of Soil Resources.

Herein, the term “soil” refers to the life-supporting upper surface of earth that is the basis of all agriculture. It contains minerals and gravel from the chemical and physical weathering of rocks, decaying organic matter (humus), microorganism, insects, nutrients, water, and air. Soils differ according to the climate, geological structure, and rainfall of the area and are constantly being formed, changed and removed by natural, animal, and human activity.

Herein, the term “pendent” refers to a chemical group covalently attached to the backbone chain of a polymer. The term “intra-chain” refers to a group within the main chain which forms the backbone of the polyurethane or polyurethane-urea elastomer.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A process for regulating the water retention of soil materials used in agriculture comprising
(a) providing a composition comprising a polymer selected from the group consisting of a urethane, a urethaneurea, a thiocarbamate and mixtures thereof, said polymer comprising hydrophobic and hydrophilic segments; and
(b) applying the composition onto soil materials used in agriculture to form a polymer film thereon, wherein the hydrophobic and hydrophilic segments together provide reversible hydrophobic-hydrophilic switching in response to water, such that the film surface switches from a relatively hydrophobic state in dry conditions to a relatively hydrophilic state in response to the presence of water in contact with the film surface.

2. The process according to claim 1, wherein the film surface undergoes a reversible change in water contact angle of at least 10°, when switching from a relatively hydrophobic state to a relatively hydrophilic state and has a water contact angle of >90° in the relatively hydrophobic state.

3. (canceled)

4. The process according to claim 1, wherein the polymer is a polymer of a diisocyanate, ester, carbonate or amide linker; a hydrophobic macromonomer having at least two active hydrogen groups selected from hydroxyl, thiol and amine, and a hydrophilic macromonomer having at least two active hydrogen groups selected from hydroxyl, thiol and amine, wherein the hydrophobic macromonomer provides said hydrophobic segment and the hydrophilic macromonomer provides said hydrophilic segment; and wherein the polymer comprises segments of hydrophobic macromonomer and hydrophobic macromonomer joined by linkages selected from urethane, urethaneurea or thiocarbamate linkages.

5. The process according to claim 4, wherein the hydrophobic macromonomer is selected from the group consisting of poly(siloxanes), poly(caprolactone), poly(lactic acid), poly(3-hydroxyalkanoates), polymers derived from fatty acids, and mixtures thereof.

6. The process according to claim 4, wherein the hydrophobic macromonomer has a molecular weight of at least at least 750.

7. The process according to claim 4, wherein the hydrophilic macromonomer is selected from the group consisting of poly(ethylene glycol), poly(saccharides), poly(vinyl alcohol), poly(glycolic acid), poly(peptides) and mixtures thereof.

8. The process according to claim 4, wherein the hydrophilic macromonomer has a molecular weight of at least at least 750.

9. The process according to claim 4, wherein the molar ratio of the hydrophobic macromonomer to the hydrophilic macromonomer is between about 0.05:0.95 and 0.95:0.05.

10. The process according to claim 4, wherein the hydrophobic macromonomer is poly(dimethylsiloxane) and the hydrophilic macromonomer is poly(ethylene glycol).

11. (canceled)

12. The process according to claim 4, wherein the polymer is derived from a reaction product that comprises no more than 5 wt % of a non-ionic chain extender.

13. The process according to claim 4, wherein the polymer is the reaction product of a diisocyanate, a hydrophobic macromonomer having at least two active hydrogen groups selected from hydroxyl, thiol and amine, a hydrophilic macromonomer having at least two active hydrogen groups selected from hydroxyl, thiol and amine, that further comprises up to 15 wt % of an ionic species.

14. The process according to claim 13, wherein the ionic species is selected from the group consisting of 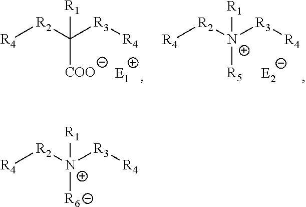
and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, 1 to 18 carbon atoms; aryl groups; aralkyl groups;
R₆ is selected from the group consisting of carboxylates, sulfonates and phosphonates;
E₁ is a counter-ion that is organic or inorganic; and
E₂ is a counter-ion that is organic or inorganic.

15. (canceled)

16. The process according to claim 4, wherein the polymer has a number average molecular weight of 30 000-200 000, preferably 50 000-120 000.

17. (canceled)

18. (canceled)

19. (canceled)

20. The process according to claim 1, wherein the composition is in the form of an aqueous dispersion.

21. The process according to claim 20, wherein the polymer is present in an amount of from 1 to 60 wt/o of the aqueous dispersion.

22. The process according to claim 20, wherein the composition is applied onto soil materials by spray application.

23. (canceled)

24. The process according to claim 1, wherein the polymer comprises a copolymer segment of Formula 1
A¹-Y¹-L-Y²-A² Formula 1
wherein
A¹ and A² which are the same or different, represent the remainder of the polymer backbone or terminal functional groups of the polymer;
Y¹ is the hydrophobic segment;
Y² is the hydrophilic segment; and
L is a divalent linking group selected from diisocyanate ester, carbonate and amide residue which forms independently selected urethane, urethaneurea or thiocarbamate linkages with each of Y¹ and Y¹.

25. The process according to claim 1, wherein the polymer comprises a copolymer segment of Formula 1a
A¹[-X¹-L¹]ₘ-Y¹[-L²-X²]ₙ-L³-Y²[-L⁴-X³]ₚ-A² Formula 1a
wherein
A¹ and A² which are the same or different, represent the remainder of the polymer backbone or terminal functional groups of the polymer;
Y¹ is the hydrophobic segment;
Y² is the hydrophilic segment;
X¹, X² and X³ are independently selected ionic species;
L¹, L², L³ and L⁴ are independently selected divalent linking group selected from diisocyanate, ester carbonate and amide residues which form independently selected urethane, urethaneurea or thiocarbamate linkages with each of Y¹, Y², X¹, X² and X³;
m is an integer of 0 or 1;
n is an integer of 0 or 1; and
p is an integer of 0 or 1, wherein at least one of m, n and p is 1.

26. The process according to claim 25, wherein X¹, X² and X³ are independently selected from the group consisting of 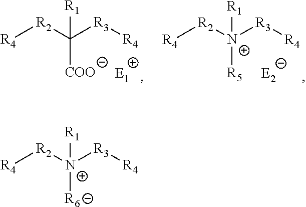
and mixtures thereof, where:
R₁ is an alkyl group of 1 to 4 carbons;
R₂ and R₃ are independently selected from the group consisting of alkyl groups of 1 to 4 carbon atoms; aryl; aralkyl; polyester and polyether moieties;
R₄ is —O or —NH, where the bond — denotes the point of attachment to the polymer backbone or terminal functional groups of the polymer; and
R₅ is selected from the group consisting of hydrogen, alkyl groups of 1 to 18 carbon atoms; aryl groups; aralkyl groups;
R₆ is selected from the group consisting of carboxylates, sulfonates and phosphonates,
E₁ is a counter-ion that is organic or inorganic; and
E2 is a counter-ion that is organic or inorganic.

27. The process according to claim 24, wherein the hydrophobic segment is selected from the group consisting of poly(siloxanes), fluoropolymers, poly(butadiene)/isoprene, poly(caprolactone), poly(lactic acid), poly(3-hydroxyalkanoates), polymers derived from fatty acids, polymers derived from lignin and mixtures thereof.

28. The process according to claim 24, wherein the hydrophilic segment is selected from the group consisting of poly(ethylene glycol), poly(saccharides), poly(vinyl alcohol), poly(glycolic acid), poly(peptides) and mixtures thereof.

29. (canceled)

30. (canceled)

31. (canceled)

32. (canceled)

33. (canceled)
